(19) United States
(12) Patent Application Publication
(10) Pub. No.: US 2021/0352889 A1
(43) Pub. Date: Nov. 18, 2021

(54) MACROCYCLIC TETRAPYRROLE COMPOUNDS, COMPOSITIONS AND METHODS FOR INCREASING ABIOTIC STRESS RESISTANCE IN PLANTS

(71) Applicant: SUNCOR ENERGY INC., Calgary (CA)

(72) Inventors: Michael Fefer, Mississauga (CA); Jun Liu, Mississauga (CA); Ken Ng, Mississauga (CA); Yuichi Terazono, Mississauga (CA); Inna Teshler, Mississauga (CA); Wenzi Ckurshumova, Mississauga (CA); Brady Nash, Mississauga (CA)

(73) Assignee: SUNCOR ENERGY INC., Calgary (CA)

(21) Appl. No.: 17/051,666

(22) PCT Filed: Apr. 29, 2019
(86) PCT No.: PCT/CA2019/050554

§ 371 Date: Oct. 29, 2020

Related U.S. Application Data
(60) Provisional application No. 62/664,619, filed on Apr. 30, 2018.

(51) Int. Cl. A01N 3/00

(52) U.S. Cl. CPC A01N 3/00

(57) ABSTRACT

A method for increasing resistance of a plant to one or more abiotic stress is provided. The method includes applying to the plant a combination including: a macrocyclic tetrapyrrole compound selected from the group consisting of a porphyrin, a reduced porphyrin and a mixture thereof; and an oil selected from the group consisting of a mineral oil, a vegetable oil and a mixture thereof. Another method for increasing resistance of a plant to one or more abiotic stress is provided. The method includes applying a macrocyclic tetrapyrrole compound selected from the group consisting of a porphyrin, a reduced porphyrin and a mixture thereof, to at least one of a seed and a seedling of the plant. Corresponding compositions are also provided.

### FIELD

The technical field generally relates to macrocyclic tetrapyrrole compounds and compositions thereof for increasing abiotic stress resistance or tolerance in plants. More particularly, the macrocyclic tetrapyrrole compounds can be porphyrin compounds, or reduced porphyrin compounds.

### BACKGROUND

Growing plants are subject to a variety of environmental stresses of a non-biological origin, referred to herein as abiotic stresses. Non-limiting examples of abiotic stresses include cold stress, heat stress, drought stress, excess water stress, photooxidative stress, and stress caused by excess salt exposure. When plants are exposed to abiotic stresses, growth may be inhibited as the plant diverts energy to biological defense mechanisms in an attempt to cope with the stress condition. One or all of these stresses can have a debilitating effect on plant health, quality and/or development and, may compromise crop yields and/or quality. The effects of abiotic stressors are especially important as it relates to climate change, as plants and growers must adapt quickly to cope with unexpected new or magnified abiotic stress conditions.

There is still a need for compounds, compositions and/or combinations that can help increase abiotic stress resistance in plants.

### SUMMARY

In one aspect, there is provided a method for increasing resistance of a plant to one or more abiotic stress, the method comprising applying to the plant a combination comprising: a macrocyclic tetrapyrrole compound selected from the group consisting of a porphyrin, a reduced porphyrin and a mixture thereof; and an oil selected from the group consisting of a mineral oil, a vegetable oil and a mixture thereof.

In another aspect, there is provided a composition for increasing resistance of a plant to one or more abiotic stress, the composition comprising: a macrocyclic tetrapyrrole compound selected from the group consisting of a porphyrin, a reduced porphyrin and a mixture thereof; and an oil selected from the group consisting of a mineral oil, a vegetable oil and a mixture thereof.

In another aspect, there is provided a method for increasing resistance of a plant to one or more abiotic stress, the method comprising applying a macrocyclic tetrapyrrole compound selected from the group consisting of a porphyrin, a reduced porphyrin and a mixture thereof, to at least one of a seed and a seedling of the plant.

In another aspect, there is provided a method for increasing resistance of a plant to one or more abiotic stress, the method comprising applying to the plant a combination comprising: a macrocyclic tetrapyrrole compound selected from the group consisting of a porphyrin, a reduced porphyrin and a mixture thereof; and a chelating agent.

In another aspect, there is provided a composition for increasing resistance of a plant to one or more abiotic stress, the composition comprising: a macrocyclic tetrapyrrole compound selected from the group consisting of a porphyrin, a reduced porphyrin and a mixture thereof; and a chelating agent.

In another aspect, there is provided a method for increasing resistance of a plant to one or more abiotic stress, the method comprising applying to the plant a combination comprising: a macrocyclic tetrapyrrole compound selected from the group consisting of a porphyrin, a reduced porphyrin and a mixture thereof; and an oil selected from the group consisting of a mineral oil, a vegetable oil and a mixture thereof; wherein the macrocyclic tetrapyrrole compound and the oil are present in amounts that are synergistically effective for increasing resistance of the plant to at least one of the one or more abiotic stress.

In another aspect, there is provided a composition for increasing resistance of a plant to one or more abiotic stress, the composition comprising: a macrocyclic tetrapyrrole compound selected from the group consisting of a porphyrin, a reduced porphyrin and a mixture thereof; and an oil selected from the group consisting of a mineral oil, a vegetable oil and a mixture thereof; wherein the macrocyclic tetrapyrrole compound and the oil are present in amounts that are synergistically effective for increasing resistance of the plant to at least one of the one or more abiotic stress.

In another aspect, there is provided a method for increasing resistance of a plant to one or more abiotic stress, the method comprising applying to the plant a combination comprising: a macrocyclic tetrapyrrole compound selected from the group consisting of a porphyrin, a reduced porphyrin and a mixture thereof; and a chelating agent comprising an aminocarboxylic acid compound or a salt thereof, wherein the macrocyclic tetrapyrrole compound and the chelating agent are present in amounts that are synergistically effective for increasing resistance of the plant to at least one of the one or more abiotic stress.

In another aspect, there is provided a composition for increasing resistance of a plant to one or more abiotic stress, the composition comprising: a macrocyclic tetrapyrrole compound selected from the group consisting of a porphyrin, a reduced porphyrin and a mixture thereof; and a chelating agent comprising an aminocarboxylic acid compound or a salt thereof, wherein the macrocyclic tetrapyrrole compound and the chelating agent are present in amounts that are synergistically effective for increasing resistance of the plant to at least one of the one or more abiotic stress.

In another aspect, there is provided a method for increasing resistance of a plant to one or more abiotic stress, the method comprising applying to the plant a combination comprising: a macrocyclic tetrapyrrole compound selected from the group consisting of a porphyrin, a reduced porphyrin and a mixture thereof; an oil selected from the group consisting of a mineral oil, a vegetable oil and a mixture thereof; and a chelating agent comprising an aminocarboxylic acid compound or a salt thereof, wherein the macrocyclic tetrapyrrole compound, the oil and the chelating agent are present in amounts that are synergistically effective for increasing resistance of the plant to at least one of the one or more abiotic stress.

In another aspect, there is provided a composition for increasing resistance of a plant to one or more abiotic stress, the composition comprising: a macrocyclic tetrapyrrole compound selected from the group consisting of a porphyrin, a reduced porphyrin and a mixture thereof; an oil selected from the group consisting of a mineral oil, a vegetable oil and a mixture thereof; and a chelating agent comprising an am inocarboxylic acid compound or a salt thereof, wherein the macrocyclic tetrapyrrole compound, the oil and the chelating agent are present in amounts that are synergistically effective for increasing resistance of the plant to at least one of the one or more abiotic stress.

### DETAILED DESCRIPTION

The compounds, combinations and formulations described herein pertain to the use of macrocyclic tetrapyrrole compounds for increasing the resistance of plants to damage caused by one or more abiotic stresses. The macrocyclic tetrapyrrole compounds can be used alone or in combination with other additives such as oils, chelating agents and/or surfactants.

The term “Abiotic stress”, as used herein, refers to environmental conditions that negatively impact growth, development, yield and/or seed quality of crop and other plants. below optimum levels. Non-limiting example of abiotic stresses include, for example: photooxidative conditions, drought (water deficit), excessive watering (flooding, and submergence), extreme temperatures (chilling, freezing and heat), extreme levels of light (high and low), radiation (UV-B and UV-A), salinity due to excessive Na⁺ (sodicity), chemical factors (e.g., pH), mineral (metal and metalloid) toxicity, deficiency or excess of essential nutrients, gaseous pollutants (ozone, sulfur dioxide), wind, mechanical factors, and other stressors.

As used herein, the term “increasing stress resistance” (and the like) refers to an increase in the ability of a plant to survive or thrive in stress conditions. Enhanced resistance or tolerance can be specific for a particular stressor, e.g., drought, excess water, nutrient deficiency, salt, cold, shade or heat, or multiple stressors. In some scenarios, increased resistance to one or more abiotic stresses can be exemplified by the reduction in degradation of quality of the plant, as compared to an untreated plant subjected to the same stress. In other scenarios, increased resistance to one or more abiotic stress can be exemplified by maintained or improved plant quality, as compared to an untreated plant subjected to the same stress.

As used herein, the hardiness of a tree, grass, crop, or plant refers to its ability to survive adverse environmental (abiotic) conditions, such as cold, heat, drought, flooding, shade, soil nutrient excess or deficiency, and wind. Natural resistance to a given adverse abiotic condition can vary by genus, species, and cultivar. For example, a certain type of fruit tree may not survive a winter in which temperatures drop to 5° C. Therefore, a grower in a climate in which winter temperatures average 10° C. may be hesitant to plant the first type of fruit tree for fear that an unusually cold winter may significantly reduce his crop and potentially destroy his orchard. Likewise, a residential vegetable farmer may plan his garden plot based on the amount of shade and sun exposure, planting heat hardy plants in the sunny location and shade hardy plants in the shaded areas.

As climatic conditions may change over time, a grower may wish to increase the hardiness of a plant, grass, tree, or crop to minimize risk of economic loss based on one or more predicted or unexpected abiotic stress. Further, growers may wish to attempt to grow crops that are not expected to thrive in their geographic zone and local soil conditions. In these circumstances, growers are typically encouraged to carefully monitor environmental conditions to mitigate risk that these conditions can result in loss of the plant or crop yield. For example, growers in cold climates may cover plants or shrubs for the winter, may supplement poor soil quality with fertilizer or other chemicals, or may construct wind screens. Methods to generally improve a plant's tolerance to abiotic stressors would allow growers to avoid or limit such steps and would enable growers to extend the natural limit of environmental conditions beyond those common to its native geographic location.

Application of the compound or a composition that include the compound to a plant, e.g., a shrub, grass, fruit or vegetable plant, flower, tree, vine, or crop (generally referred to herein as a plant) can improve the hardiness of the plant and can allow the plant to withstand growing conditions that are outside the range of native growing conditions for that plant. Such conditions are considered to be abiotic stressors. Examples of specific abiotic stress conditions are described below.

Plant's ability to withstand abiotic stresses can be enhanced by applying a macrocyclic tetrapyrrole compound described herein. The macrocyclic tetrapyrrole compound can be photoactive or non-photoactive, metallated or non-metallated. The macrocyclic tetrapyrrole compound can be added as a standalone compound or in combination with other additives, or as part of a composition including other additives. The other additives can include an oil, a chelating agent, a surfactant, water, or combinations thereof. The macrocyclic tetrapyrrole compounds and the additives are also described in greater detail below.

### Macrocyclic Tetrapyrrole Compounds

In the present description, the abiotic stress resistance enhancing compound is a macrocyclic tetrapyrrole compound. The macrocyclic tetrapyrrole compound can include four nitrogen-bearing heterocyclic rings linked together. In some implementations, the nitrogen-bearing heterocyclic rings are selected from the group consisting of pyrroles and pyrrolines, and are linked together by methine groups (i.e., ═CH— groups) to form tetrapyrroles. The macrocyclic tetrapyrrole compound can for example include a porphyrin compound (four pyrrole groups linked together by methine groups), a chlorin compound (three pyrrole groups and one pyrroline group linked together by methine groups), a bacteriochlorin compound or an isobacteriochlorin compound (two pyrrole groups and two pyrroline groups linked together by methine groups), or a functional equivalent thereof having a heterocyclic aromatic ring core or a partially aromatic ring core (i.e., a ring core which is not aromatic through the entire circumference of the ring). It should also be understood that the term “reduced porphyrin” as used herein, refers to the group consisting of chlorin, bacteriochlorin, isobacteriochlorin and other types of reduced porphyrins such as corrole, corrin and corphin. It should be understood that the macrocyclic tetrapyrrole compound can be a metal complex (e.g., an Mg-porphyrin) or a non-metal macrocycle (e.g., chlorin E6, Protoporphyrin IX or Tetra Phenyl Porphyrin). The macrocyclic tetrapyrrole compound can be an extracted naturally-occurring compound, or a synthetic compound.

In implementations where the porphyrin or a reduced porphyrin compound is metallated, the metal can be chosen such that the metallated macrocyclic tetrapyrrole compound generates reactive oxygen species (ROS) or can be chosen such that the metallated macrocyclic tetrapyrrole compound does not generate ROS or does not generate singlet oxygen species, and/or is non-photosensitive. Non-limiting examples of metals include Mg, Zn, Pd, Sn, Al, Pt, Si, Ge, Ga, In, Ni, Cu, Co, Fe and Mn. It should be understood that when a metal species is mentioned without its degree of oxidation, all suitable oxidation states of the metal species are to be considered, as would be understood by a person skilled in the art. In other implementations, the metal is selected from the group consisting of Mg, Zn, Pd, Sn, Al, Pt, Si, Ge, Ga and In, or selected from the group consisting of Mg(II), Zn(II), Pd(II), Sn(IV), Al(III), Pt(II), Si(IV), Ge(IV), Ga(III) and In(III). In yet other implementations, the metal selected from the group consisting of Cu, Co, Fe and Mn, or selected from the group consisting of Cu(II), Co(II),Co(III), Fe(II), Fe(III), Mn(II) and Mn(III).

It should be understood that the macrocyclic tetrapyrrole compound to be used in the methods and compositions of the present description can also be selected based on their toxicity to humans or based on their impact on the environment. For example, porphyrins and reduced porphyrins tend to have a lower toxicity to humans as well as enhanced environmental biodegradability properties when compared to other types of macrocyclic tetrapyrrole compounds such as phthalocyanines.

The following formulae illustrate several non-limiting examples of macrocyclic tetrapyrrole compounds:

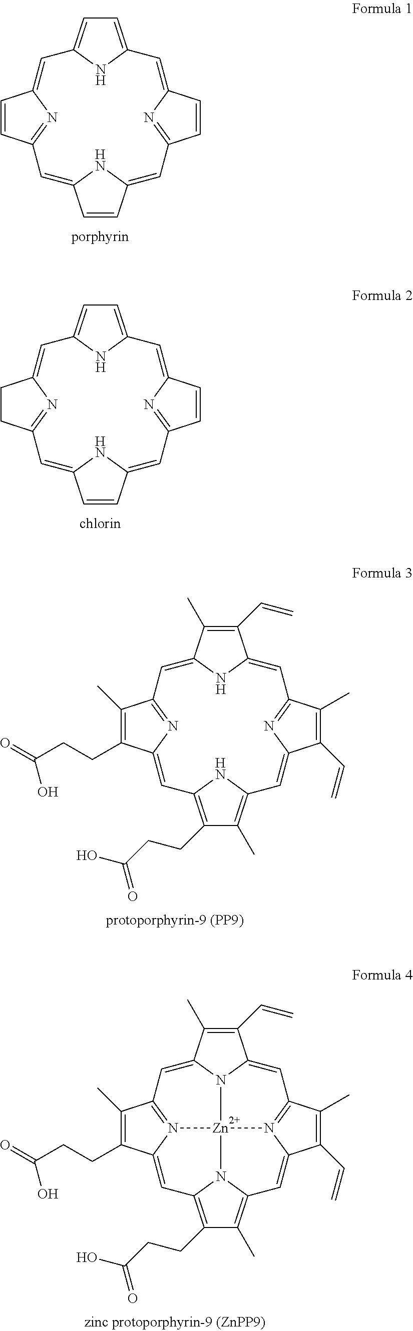

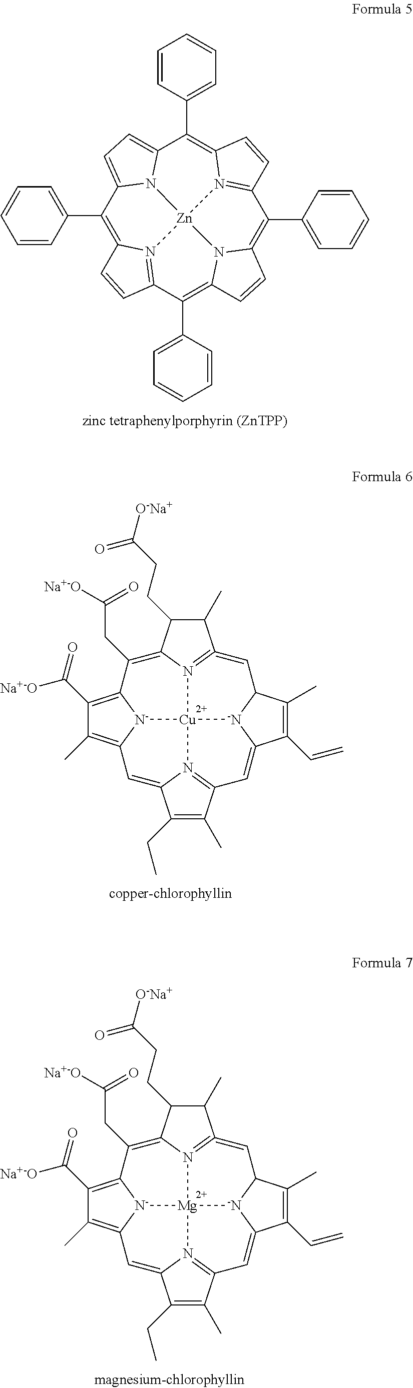

The macrocyclic tetrapyrrole compounds such as copper chlorophyllin (also referred to herein a CuChIn or CuChI) and magnesium chlorophyllin (also referred to herein as MgChIn or MgChI) can be obtained from various chemical suppliers such as Organic Herb Inc., Sigma Aldrich or Frontier Scientific. In some scenarios, the macrocyclic tetrapyrrole compounds are not 100% pure and may include other components such as organic acids and carotenes. In other scenarios, the macrocyclic tetrapyrrole compounds can have a high level of purity.

### Additives

In some implementations, the macrocyclic tetrapyrrole compound can be applied to a plant in combination with one or more agriculturally suitable adjuvants. Each of the one or more agriculturally suitable adjuvants can be independently selected from the group consisting of one or more activator adjuvants (e.g., one or more surfactants; e.g., one or more oil adjuvants, e.g., one or more penetrants) and one or more utility adjuvants (e.g., one or more wetting or spreading agents; one or more humectants; one or more emulsifiers; one or more drift control agents; one or more thickening agents; one or more deposition agents; one or more water conditioners; one or more buffers; one or more anti-foaming agents; one or more UV blockers; one or more antioxidants; one or more fertilizers, nutrients, and/or micronutrients; and/or one or more herbicide safeners). Exemplary adjuvants are provided in Hazen, J. L. Weed Technology 14: 773-784 (2000), which is incorporated by reference in its entirety.

In some implementations, the macrocyclic tetrapyrrole compound can be applied to a plant in combination with oil. The oil can be selected from the group consisting of a mineral oil (e.g., paraffinic oil), a vegetable oil, an essential oil, and a mixture thereof. In some scenarios, combining the macrocyclic tetrapyrrole compound with an oil can improve solubility of the macrocyclic tetrapyrrole compound when in contact with the plant. The oil can be added with the macrocyclic tetrapyrrole compound, or separately, in the presence or absence of a carrier fluid such as water.

Non-limiting examples of vegetable oils include oils that include medium chain triglycerides (MCT), oil extracted from nuts. Other non-limiting examples of vegetable oils include coconut oil, canola oil, soybean oil, rapeseed oil, sunflower oil, safflower oil, peanut oil, cottonseed oil, palm oil, rice bran oil or mixtures thereof. Non-limiting examples of mineral oils include paraffinic oils, branched paraffinic oils, naphthenic oils, aromatic oils or mixtures thereof.

Non-limiting examples of paraffinic oils include various grades of poly-alpha-olefin (PAO). For example, the paraffinic oil can include HT60™, HT100™, High Flash Jet, LSRD™, and N65DW™. The paraffinic oil can include a paraffin having a number of carbon atoms ranging from about 12 to about 50, or from about 16 to 35. In some scenarios, the paraffin can have an average number of carbon atoms of 23. In some implementations, the oil can have a paraffin content of at least 80 wt %, or at least 90 wt %, or at least 99 wt %.

The macrocyclic tetrapyrrole compound and the oil can be added sequentially or simultaneously. When added simultaneously, the macrocyclic tetrapyrrole compound and the oil can be added as part of the same composition or as part of two separate compositions. In some implementations, the macrocyclic tetrapyrrole compound and the oil can be combined in an oil-in-water emulsion. That is, the combination can include the macrocyclic tetrapyrrole compound combined with the oil and water so that the macrocyclic tetrapyrrole compound is formulated as an oil-in-water emulsion. The oil-in-water emulsion can also include other additives such as a chelating agent, a surfactant or combinations thereof.

As used herein, the term “oil-in-water emulsion” refers to a mixture in which one of the oil (e.g., the paraffinic oil) and water is dispersed as droplets in the other (e.g., the water). In some implementations, an oil-in-water emulsion is prepared by a process that includes combining the paraffinic oil, water, and any other components and the paraffinic oil and applying shear until the emulsion is obtained. In other implementations, an oil-in-water emulsion is prepared by a process that includes combining the paraffinic oil, water, and any other components in the mixing tank and spraying through the nozzle of a spray gun.

In some implementations, the macrocyclic tetrapyrrole compound is part of a composition that includes a carrier fluid. A suitable carrier fluid can allow obtaining a stable solution, suspension and/or emulsion of the components of the composition in the carrier fluid. In some implementations, the carrier fluid is water. In other implementations, the carrier fluid is a mixture of water and other solvents or oils that are non-miscible or only partially soluble in water.

In some implementations, a combination of macrocyclic tetrapyrrole compound and oil can be used to increase the resistance of a plant to an abiotic stress. The combination can be an oil-in-water emulsion, where the surfactant is selected such that the macrocyclic tetrapyrrole compound is maintained in dispersion in the oil-in-water emulsion for delivery to the plant.

The combination can include a surfactant (also referred to as an emulsifier or as a surface-active agent). Surfactants typically have a characteristic molecular structure comprising a hydrophobic group and a hydrophilic group (i.e., an amphiphilic structure). The hydrophobic group can be a long-chain hydrocarbon and the hydrophilic group is typically an ionic or a highly polar group. Depending on the nature of the hydrophilic group, surfactants can be classified as anionic, cationic, nonionic and amphoteric. The combination of the present description can include at least one of an anionic, cationic, nonionic and amphoteric surfactants. Surfactants can include various types of hydrophobic groups and hydrophilic groups. Non-limiting examples of hydrophobic groups include C₈-C₂₀ linear or branched alkyl chains, C₈-C₂₀ alkylbenzene residues, C₈-C₂₀ linear or branched etoxylated chains, C₈-C₂₀ alkylphenol residues, C₈-C₂₀ amino-propylamine residues. Non-limiting examples of hydrophilic groups include carboxylate groups, sulphonate groups, sulphate groups, tetraalkylammonium groups, PEG groups, PEG ester groups, PEG phenol ester groups, PEG amine groups, glucose groups or other saccharides, amino-acid amphoteric groups.

In some implementations, the surfactant can be selected from the group consisting of an ethoxylated alcohol, a polymeric surfactant, a fatty acid ester, a polyethylene glycol, an ethoxylated alkyl alcohol, a monoglyceride, an alkyl monoglyceride and a mixture thereof. For example, the fatty acid ester can be a sorbitan fatty acid ester. The surfactant can be present as an adjuvant to aid coverage of plant foliage. The surfactant can be an acceptable polysorbate type surfactant (e.g., Tween 80), a nonionic surfactant blend (e.g., Atlox™ 3273), or another suitable surfactant. In some implementations, the polyethylene glycol can include a polyethylene glycol of Formula:

R¹—O—(CH₂CH₂O)_{f}—R²
wherein R¹═H, CH₂═CH—CH₂ or COCH₃; R²═H, CH₂═CH—CH₂ or COCH₃; and f≥1.

The combination can also include a chelating agent. In some implementations, the chelating agent can include at least one carboxylic group, at least one hydroxyl group, at least one phenol group and/or at least one amino group or an agriculturally acceptable salt thereof. In some implementations, the chelating agent can include an aminocarboxylic acid compound or an agriculturally acceptable salt thereof. The aminocarboxylic acid or agriculturally acceptable salt thereof can include an amino polycarboxylic acid or an agriculturally acceptable salt thereof. For example, the amino polycarboxylic acid can include two amino groups and two alkylcarboxyl groups bound to each amino group. The alkylcarboxyl groups can be methylcarboxyl groups.

In some implementations, the chelating agent is selected from the group consisting of: an aminopolycarboxylic acid, an aromatic or aliphatic carboxylic acid, an amino acid, a phosphonic acid, and a hydroxycarboxylic acid or an agriculturally acceptable salt thereof.

In some implementations, the methods and compositions described herein include one or more aminopolycarboxylic acid chelating agents. Examples of aminopolycarboxylic acid chelating agents include, without limitation, ethylenediaminetetraacetic acid (EDTA), diethylenetriaminepentaacetic acid (DTPA), hydroxyethylenediaminetriacetic acid (HEDTA), and ethylenediaminedisuccinate (EDDS), cyclohexanediaminetetraacetic acid (CDTA), N-(2-hydroxyethyl)ethylenediaminetriacetic acid (HEDTA) glycol ether diaminetetraacetic acid (GEDTA), alanine diacetic acid (ADA), alkoyl ethylene diamine triacetic acids (e.g., lauroyl ethylene diamine triacetic acids (LED3A)), aspartic acid diacetic acid (ASDA), aspartic acid monoacetic acid, diamino cyclohexane tetraacetic acid (CDTA), 1,2-diaminopropanetetraacetic acid (DPTA-OH), 1,3-diamino-2-propanoltetraacetic acid (DTPA), diethylene triamine pentam ethylene phosphonic acid (DTPMP), diglycolic acid, dipicolinic acid (DPA), ethanolamine diacetic acid, ethanol diglycine (EDG), ethylenediaminediglutaric acid (EDDG), ethylenediaminedi(hydroxyphenylacetic acid (EDDHA), ethylenediaminedipropionic acid (EDDP), ethylenediaminedisuccinate (EDDS), ethylenediaminemonosuccinic acid (EDMS), ethylenediaminetetraacetic acid (EDTA), ethylenediaminetetrapropionic acid (EDTP), and ethyleneglycolaminoethylestertetraacetic acid (EGTA) and agriculturally acceptable salts (for example, the sodium salts, calcium salts and/or potassium salts) thereof.

One non-limiting example of chelating agent is ethylenediaminetetraacetic acid (EDTA) or an agriculturally acceptable salt thereof. The aminocarboxylate salt can for example be a sodium or calcium salt.

Another non-limiting example of chelating agent is polyaspartic acid or a salt thereof (i.e., a polyaspartate), such as sodium polyaspartate, which can be generally represented as follows. The molecular weight of the polyaspartate salt can for example be between 2,000 and 3,000.

The chelating agent can thus be a polymeric compound, which can include aspartate units, carboxylic groups, and other features found in polyaspartates. The polyaspartate can be a co-polymer that has alpha and beta linkages, which may be in various proportions (e.g., 30% alpha, 70% beta, randomly distributed along the polymer chain). One non-limiting example of a sodium polyaspartate is Baypure® DS 100.

Other non-limiting examples of chelating agents include EDDS (ethylenediamine-N,N′-disuccinic acid), IDS (iminodisuccinic acid (N-1,2-dicarboxyethyl)-D,L-aspartic acid), isopropylamine, triethanolamine, triethylamine, ammonium hydroxide, tetrabutylammonium hydroxide, hexamine, GLDA (L-glutamic acid N,N-diacetic acid), or agriculturally acceptable salts thereof. The chelating agent can be metallated or non-metallated. In some implementations, IDS can be used as a tetrasodium salt of IDS (e.g., tetrasodium iminodisuccinate), which can be Baypure® CX100. In some implementations, EDDS can be used as a trisodium salt of EDDS. In some implementations, GLDA can be used as a tetrasodium salt of GLDA.

In some implementations, the chelating agent can include one or more amino acid chelating agents. Examples of amino acid chelating agents include, without limitation, alanine, arginine, asparagine, aspartic acid, glutamic acid, glutamine, glycine, histidine, isoleucine, leucine, lysine, methionine, proline, serine, threonine, tyrosine, valine, or salts (for example, the sodium salts, calcium salts and/or potassium salts) and combinations thereof.

In some implementations, the chelating agent can include one or more aromatic or aliphatic carboxylic acid chelating agents. Examples of aromatic or aliphatic carboxylic acid chelating agents include, without limitation, oxalic acid, succinic acid, pyruvic acid malic, acid, malonic acid, salicylic acid, and anthranilic acid, and salts (for example, the sodium salts, calcium salts and/or potassium salts) thereof. In some implementations, the methods and compositions described herein include one or more polyphenol chelating agents. One non-limiting example of a polyphenol chelating agent is tannins such as tannic acid.

In some implementations, the chelating agent can include one or more hydroxycarboxylic acid chelating agents. Examples of the hydroxycarboxylic acid type chelating agents include, without limitation, malic acid, citric acid, glycolic acid, heptonic acid, tartaric acid and salts (for example, the sodium salts, calcium salts and/or potassium salts) thereof.

It will be understood that the one or more chelating agents can be provided as the free acid, as an agriculturally acceptable salt, or as combinations thereof. In some implementations, each of one or more the chelating agent(s) is applied as the free acid. In other implementations, the chelating agent(s) can be applied as a salt. Exemplary salts include sodium salts, potassium salts, calcium salts, ammonium salts, amine salts, amide salts, and combinations thereof. In still other implementations, when more than one chelating agent is present, at least one of the chelating agents is applied as a free acid, and at least one of the chelating agents is applied as a salt.

It should also be understood that the macrocyclic tetrapyrrole compounds and the other agents (e.g., chelating agent, oil, surfactant, etc.) can be provided to a plant separately or together as part of the same composition. In some implementations, the components of the compositions can be packaged in a concentrated form, without carrier fluid, and the carrier fluid (e.g., water) can be added to form the composition directly by the operator that can then apply the composition to plants.

When the components are provided as part of a single composition, the composition can be provided to have certain concentrations and relative proportions of components. For example, the composition can have between about 100 nM and about 50 mM, between about 5 micromolar and about 100 mM, between about 5 micromolar and about 50 mM, between about 5 micromolar and about 10 mM, between about 1 micromolar and about 1000 micromolar, between about 5 micromolar and about 200 micromolar of the macrocyclic tetrapyrrole compound, between about 10 micromolar and about 150 micromolar of the macrocyclic tetrapyrrole compound, between about 25 micromolar and about 100 micromolar of the macrocyclic tetrapyrrole compound, or between about 50 micromolar and about 75 micromolar of the macrocyclic tetrapyrrole compound.

For example, and without being limiting, the composition can also include between about 2 micromolar and about 10,000 micromolar of the chelating agent, between about 5 micromolar and about 5,000 micromolar of the chelating agent, between about 10 micromolar and about 1,000 micromolar of the chelating agent, between about 25 micromolar and about 500 micromolar of the chelating agent, between about 50 micromolar and about 100 micromolar of the chelating agent.

For example, and without being limiting, the relative proportion, by weight, of the macrocyclic tetrapyrrole compound and the chelating agent in the composition can be between about 50:1 and about 1:1000, between about 20:1 and about 1:500, between about 10:1 and about 1:100, or between about 1:1 and about 1:10.

For example, and without being limiting, the macrocyclic tetrapyrrole compound and the oil can be applied in a relative proportion, by weight, between about 50:1 and about 1:1000, between about 20:1 and about 1:500, between about 10:1 and about 1:100, or between about 1:1 and about 1:10.

### Modes of Application

The macrocyclic tetrapyrrole compound can be applied to plants to increase their ability to withstand abiotic stress. The compound can be applied along with other additives either simultaneously or separately, to the plants. For example, a composition can be prepared to include the macrocyclic tetrapyrrole compound and other optional additives such as oil, chelating agent and/or surfactant, as well as a delivery fluid, such as water or a water-oil emulsion.

The macrocyclic tetrapyrrole compound or composition described herein can be applied to the foliage, seeds, roots and/or stem of the plant. The compound or composition can be applied to the plant by seed dipping or coating, root dipping, seedling root dipping, soil drench, pipetting, irrigating, spraying, misting, sprinkling, pouring, foliar spray, spraying at the base of the plants, or any other suitable method.

In some implementations, the macrocyclic tetrapyrrole compound can be used to treat seeds or seedlings. In some scenarios, the treatment of seeds or seedlings can stimulate germination and growth, and/or can increase resistance of the plant to abiotic stresses. In some implementations, the seeds or seedlings can be treated with the macrocyclic tetrapyrrole compound prior to being planted into a growing medium. In some implementations, the seeds or seedlings can be treated with the macrocyclic tetrapyrrole compound after being planted into a growing medium.

The macrocyclic tetrapyrrole compound can be directly surface-coated onto the seeds, seedlings roots or seedlings leafs (foliar application on seedlings). In some implementations, a solution or emulsion containing the macrocyclic tetrapyrrole compound can be directly sprayed onto the seeds or seedlings. In some implementations, the seeds or seedlings can be dipped into a solution or emulsion containing the macrocyclic tetrapyrrole compound. In some implementations, the root of the seedling can be dipped into a solution or emulsion containing the macrocyclic tetrapyrrole compound. In some implementations, the seeds can be placed into a container, and a solution containing the macrocyclic tetrapyrrole compound can be introduced into the container. The container can then be shaken for an appropriate period (e.g., between about 1 minute to several minutes) such that the solution contacts the seeds. The shaken seeds can then be dried (e.g., air dried) prior to being planted.

The macrocyclic tetrapyrrole compound can be applied once, twice, or more than twice to seeds or seedlings, using various modes applications. For example, the seeds can be treated after having been planted into a growing medium. In another example, the seeds and/or seedlings can be treated prior to having been planted and after having been planted (e.g., in furrow treatment and/or foliar application). In yet another example, the seed can be treated prior to having been planted and/or after having been planted, and the ensuing seedling can be further treated (e.g., root treatment and/or foliar treatment).

Coating Compositions with Resin

In some implementations, water-based compositions including a porphyrin compound or reduced porphyrin compound and a resin can be used for coating a seed or seedling. The resin can include any suitable polymeric species that are dispersible in an aqueous carrier medium. For example, the resin can be selected from the group consisting of acrylics (e.g., methacrylics), polyurethanes, urethane acrylics, polyesters and uralkyds.

It should be understood that the chemical structure or composition of the resin can be modified to obtain desired coating properties. For example, controlling the hydrophilicity and hydrophobicity of the resin can change the water permeability of the coating. Modifying the glass transition temperature (Tg) of the various polymer phases (e.g., when the resin is a multiple phase polymer) can control coating hardness and adhesion. Additional functional groups can also be introduced (e.g., (poly)amine, amide, cyclic ureido, acid, hydroxyl, acetoacetoxy, tertiary amine) to the resin in order to modify the adhesion of the coating to the seeds or seedlings. In some scenarios, the coating composition including a resin can be film forming.

In some embodiments, the coating composition can include between about 30 wt % to about 60 wt % water, between about 0.001 wt % to about 40 wt % of a porphyrin compound or reduced porphyrin compound, and between about 5 wt % to about 30 wt % of a resin. For example, the coating composition can include about 50 wt % water, about 40 wt % of a porphyrin compound or reduced porphyrin compound and about 10 wt % of a resin.

### Types of Plants

The combinations of the present description may be used for various types of plants that are affected by abiotic stresses. The plant can be a non-woody crop plant, a woody plant or a turfgrass. The plant can be selected from the group consisting of a crop plant, a fruit plant, a vegetable plant, a legume plant, a cereal plant, a fodder plant, an oil seed plant, a field plant, a garden plant, a green-house plant, a house plant, a flower plant, a lawn plant, a turfgrass, a tree such as a fruit-bearing tree, and other plants that may be affected by abiotic stresses.

In some implementations, the plant is a crop plant selected from the group consisting of sugar cane, wheat, rice, corn (maize), potatoes, sugar beets, barley, sweet potatoes, cassava, soybeans, tomatoes, and legumes (beans and peas).

In other implementations, the plant is a tree selected from the group consisting of deciduous trees and evergreen trees. Examples of trees include, without limitation, maple trees, fruit trees such as citrus trees, apple trees, and pear trees, an oak tree, an ash tree, a pine tree, and a spruce tree.

In yet other implementations, the plant is a shrub.

In yet other implementations, the plant is a fruit or nut plant. Non-limiting examples of such plants include: acerola (barbados cherry), atemoya, carambola (star fruit), rambutan, almonds, apricots, cherries, nectarines, peaches, pistachio, apples, avocados, bananas, plantains, blueberries, bushberries, caneberries, raspberries, figs, grapes, mango, olives, papaya, pears, pineapple, plums, strawberries, grapefruit, lemons, limes, oranges (e.g., navel and Valencia), tangelos, tangerines, mandarins.

In other implementations, the plant is a vegetable plant. Non-limiting examples of such plants include: asparagus, bean, beets, broccoli, Chinese broccoli, broccoli raab, brussels sprouts, cabbage, cauliflower, Chinese cabbage (e.g., bok choy and napa), Chinese mustard cabbage (gai choy), cavalo broccoli, collards, kale, kohlrabi, mizuna, mustard greens, mustard spinach, rape greens, celery, chayote, Chinese waxgourd, citron melon, cucumber, gherkin, hyotan, cucuzza, hechima, Chinese okra, balsam apple, balsam pear, bitter melon, Chinese cucumber, true cantaloupe, cantaloupe, casaba, crenshaw melon, golden pershaw melon, honeydew melon, honey galls, mango melon, Persian melon, pumpkin, summer squash, winter squash, watermelon, dasheen (taro), eggplant, ginger, ginseng, herbs and spices (e.g., curly leaf basil, lemon balm, cilantro, Mexican oregano, mint), Japanese radish (daikon), lettuce, okra, peppers, potatoes, radishes, sweet potatoes, Chinese artichoke (Japanese artichoke), corn and tomatoes.

In other implementations, the plant is a flowering plant, such as roses, flowering shrubs or ornamentals. Non-limiting examples of such plants include: flowering and foliage plants including roses and other flowering shrubs, foliage ornamentals & bedding plants, fruit-bearing trees such as apple, cherry, peach, and pear trees, non-fruit-bearing trees, shade trees, ornamental trees, and shrubs (e.g., conifers, deciduous and broadleaf evergreens & woody ornamentals).

In some implementations, the plant is a houseplant. Non-limiting examples of such plants include chrysanthemum, dieffenbachia, dracaena, ferns, gardenias, geranium, jade plant, palms, philodendron, and schefflera.

In some implementations, the plant is a plant grown in a greenhouse. Non-limiting examples of such plants include: ageratum, crown of thorns, dieffenbachia, dogwood, dracaena, ferns, ficus, holly, lisianthus, magnolia, orchid, palms, petunia, poinsettia, schefflera, sunflower, aglaonema, aster, azaleas, begonias, browallia, camellias, carnation, celosia, chrysanthemum, coleus, cosmos, crepe myrtle, dusty miller, easter lilies, fuchsia, gardenias, gerbera, helichrysum, hibiscus foliage, hydrangea, impatiens, jade plant, marigold, new guinea, impatiens, nicotiana , philodendron, portulaca, rieger begonias, snapdragon, and zinnias.

In some implementations, the plant is a turfgrass. As used herein, the term “turfgrass” refers to a cultivated grass that provides groundcover, for example a turf or lawn that is periodically cut or mowed to maintain a consistent height. Grasses belong to the Poaceae family, which is subdivided into six subfamilies, three of which include common turfgrasses: the Festucoideae subfamily of cool-season turfgrasses; and the Panicoideae and Eragrostoideae subfamilies of warm-season turfgrasses. A limited number of species are in widespread use as turfgrasses, generally meeting the criteria of forming uniform soil coverage and tolerating mowing and traffic. In general, turfgrasses have a compressed crown that facilitates mowing without cutting off the growing point. In the present context, the term “turfgrass” includes areas in which one or more grass species are cultivated to form relatively uniform soil coverage, including blends that are a combination of differing cultivars of the same species, or mixtures that are a combination of differing species and/or cultivars.

### Cold Hardiness

When the abiotic stress is cold stress, application of the macrocyclic tetrapyrrole compound, alone or in combination with additives such as an oil, a surfactant and/or a chelating agent, can improve cold hardiness of the plant. That is, application of the macrocyclic tetrapyrrole compound can allow the plant to withstand temperature conditions that are colder than would typically be experienced in the plant's optimal or native growing conditions. Various types of cold stress are possible, such as unexpected frost (for example an early fall frost when healthy crop, fruit, grain, seeds or leaves are still present on the plant, or a late spring frost that occurs after spring plant growth has begun), a cooler than average growing season, colder than native winter conditions, minimal winter snow cover, ice accumulation, etc.

It should be noted that what constitutes a cold stress condition for one plant may not be a cold stress condition for another plant. With reference to the USDA zone map, a cold stress condition for a zone 9 plant may in fact be a native growing condition for a zone 8 plant. Likewise, the depth of snow cover required for survival of one type of plant may not be required for a second type of plant. It is therefore understood that various types of cold stress are possible, depending on the type of plant in question.

The macrocyclic tetrapyrrole compound, compositions or combinations described herein may be used to protect plants, including woody plants, non-woody plants and turfgrasses, from frost injury. The frost can be an early frost, for example before harvest, after harvest and before dormancy. The frost can be a late frost, for example after budding. The cold damage can also be winter kill induced by winter temperatures, which may result in a loss of viable branches or shoots and lead to plant mortality Plants treated by the macrocyclic tetrapyrrole compound, compositions or combinations described herein can be frost or cold sensitive plants, in that they are naturally susceptible to frost, freezing or cold damage or injury in economically or aesthetically significant amounts.

Increasing resistance to cold stress can be exemplified by a delayed onset of dormancy. Plant dormancy can be triggered by a drop-in temperature, e.g., the onset of cold stress. By increasing resistance of the plant to cold stress, dormancy of the plant can be delayed until triggered by a further drop in temperature.

The macrocyclic tetrapyrrole compound, compositions or combinations described herein can be used periodically (e.g., at a 2 or 3-week intervals starting with spring at breaking the dormancy) and/or by applying one or more treatments (e.g., 2 in the fall), to provide a response in reducing or delaying the dormancy period of certain plants.

As used herein, the term “reducing dormancy period” refers to a plant that has a reduced dormancy period or extended growing period relative to a control, e.g., a non-treated plant.

In some implementations, the harvesting step may be carried out one week, one month, two months or more after the last application of the macrocyclic tetrapyrrole compound, compositions or combinations described herein, with the active agent still being effective to reduce the effects of cold stress on the plant during the intervening period.

In some scenarios, resistance to cold stress includes resistance to early or late frost, or winter damage. In some scenarios, the macrocyclic tetrapyrrole compound, compositions or combinations described herein can be used to protect early growth from cold during fluctuations in temperature (e.g., in early spring). In some scenarios, the macrocyclic tetrapyrrole compound, compositions or combinations described herein can be used to protect plants from cold during the cold months (e.g., in winter).

In some scenarios, the macrocyclic tetrapyrrole compound, compositions or combinations described herein can be applied by soil drenching and/or foliar application (e.g., sprayed until run-off) at the onset or prior to exposure to the low temperature (e.g., late fall when the trees have full healthy and vigorous foliage. In some scenarios, the macrocyclic tetrapyrrole compound, compositions or combinations described herein can be applied by soil drenching and/or foliar application (e.g., sprayed until run-off) during late fall and winter. In some scenarios, the macrocyclic tetrapyrrole compound, compositions or combinations described herein can be applied by soil drenching in the late fall following by a foliar application (e.g., sprayed until run-off) in the winter in order to reach maximum hardiness.

In some scenarios, the macrocyclic tetrapyrrole compound, compositions or combinations described herein can be applied 1-4 times (e., 2-4) at a 1 to 6-month interval (e.g., every 2 to 3 months). Further treatments may be applied in the spring and/or during the growing season to improve resistance to subsequent cold stress conditions. In some scenarios, the macrocyclic tetrapyrrole compound, compositions or combinations described herein can be applied in November, January, February and March for certain types of plants (e.g., apple trees) and November and January for other types of plants (e.g., peach trees).

### Heat Hardiness

When the abiotic stress is heat stress, application of the macrocyclic tetrapyrrole compound, compositions or combinations described herein can improve tolerance to high temperatures during the growing season. That is, application of the macrocyclic tetrapyrrole compound, compositions or combinations described herein can allow the plant to withstand temperature conditions that are higher than would typically be experienced in the plant's optimal or native growing conditions. Heat stress can have various causes, such as lack of shade for plants that typically require shaded growing conditions, or higher than normal summer temperatures.

It should be noted that what constitutes a heat stress condition for one plant may not be a heat stress condition for another plant.

### Photooxidative Hardiness

When the abiotic stress is photooxidative stress, application of the macrocyclic tetrapyrrole compound, compositions or combinations described herein can improve tolerance to stressful light condition during periods of increased generation of reactive oxygen species. That is, application of the macrocyclic tetrapyrrole compound, compositions or combinations described herein can allow the plant to withstand light exposure conditions (e.g., ultraviolet irradiation conditions) that are higher than would typically be experienced in the plant's optimal or native growing conditions. Photooxidative stress can have various causes, such as high light conditions or certain types of lighting that induce formation of free radicals.

It should be noted that what constitutes a photooxidative stress condition for one plant may not be a photooxidative stress condition for another plant.

### Shade Hardiness

Shade stress, or “low light (LL) stress” can be a problem that influences plant growth and quality. When the abiotic stress is shade stress, application of the macrocyclic tetrapyrrole compound, compositions or combinations described herein can improve shade hardiness of the plant. That is, application of the macrocyclic tetrapyrrole compound, compositions or combinations described herein can allow the plant to withstand shady conditions for plants whose optimal or native growing conditions typically require partial or full sun exposure. Various types of shade stress are possible, such as a prolonged period of cloudy weather, excessive growth of adjacent plants or trees that cast shade onto the plant, or lack of availability of a sunny planting location.

Shade can be a periodic problem. For example, during certain months of the year, a structure situated near a plant may cast a shadow on the plant, causing a shade stress. As the earth moves over the course of a year, the structure may no longer cast the shadow on the plant for another series of months and then the situation can be repeated during the next annual cycle. In such instances, the macrocyclic tetrapyrrole compound, compositions or combinations described herein can be applied to the plant prior to onset of the period of shade stress and can also be applied during the period of shade stress. The damage to the plant that would typically result on account of the period of shade stress can be prevented or reduced.

Shade conditions are not considered to be an abiotic stress condition for many types of plants, as some plants have a requirement for shade as part of their optimal growing conditions. It should also be noted that what constitutes a shade stress condition for one plant may not be a shade stress condition for another plant.

### Drought Hardiness

Drought can be defined as the absence of rainfall or irrigation for a period of time sufficient to deplete soil moisture and injure plants. Drought stress results when water loss from the plant exceeds the ability of the plant's roots to absorb water and/or when the plant's water content is reduced enough to interfere with normal plant processes. The severity of the effect of a drought condition may vary between plants, as the plant's need for water may vary by plant type, plant age, root depth, soil quality, etc.

The macrocyclic tetrapyrrole compound, compositions or combinations described herein can be applied to a plant prior to onset of a drought and/or during a drought. Application of the macrocyclic tetrapyrrole compound, compositions or combinations described herein can increase the resistance of the plant to the drought stress. Increasing resistance can include maintaining or increasing a quality of the plant as compared to an untreated plant subjected to the same drought stress. Increasing resistance can include reducing the degradation in quality of the plant, as compared to an untreated plant subjected to the same drought stress. If plants do not receive adequate rainfall or irrigation, the resulting drought stress can reduce growth more than all other environmental stresses combined.

It should also be noted that what constitutes a drought stress condition for one plant may not be a drought stress condition for another plant.

### Prevention of Salt Damage

Salts can be naturally present in the growing environment of a plant. Salinity stress refers to osmotic forces exerted on a plant when the plant is growing in a salt marsh or under other excessively saline conditions. For example, plants growing near a body of salt water can be exposed to salt present in the air or in water used to water the plants. In another example, salt applied to road, sidewalk and driveway surfaces during the winter for improved driving conditions can be transferred and/or leach into the soil of plants growing in the proximity. Such increased salt content in a growing environment of the plant can result in salinity stress, which can damage the plant.

Application of the macrocyclic tetrapyrrole compound, compositions or combinations described herein to the plant can increase the plant's resistance to the salinity stress and prevent or reduce a deterioration in quality of the plant which would occur if untreated. The combination can be applied prior to or during the period of salinity stress.

It should also be noted that what constitutes a salt stress condition for one plant may not be a salt stress condition for another plant.

### Transplant Shock Hardiness

A plant that is subjected to a transplant from one growing environment to another, e.g., from a pot to flower bed or garden, can be subjected to transplant shock stress as a result of exposure to new environmental conditions such as wind, direct sun, or new soil conditions. Application of the macrocyclic tetrapyrrole compound, compositions or combinations described herein to the roots of the plant can reduce the impact to the plant caused by the transplant. In some scenarios, stunting of plant growth and/or development of a transplanted plant can be reduced or prevented by application of the macrocyclic tetrapyrrole compound, compositions or combinations described herein.

It should be noted that what constitutes a transplant shock stress condition for one plant may not be a transplant shock stress condition for another plant.

### Excess Water or Flooding Hardiness

Although plants require a certain volume of water for healthy plant growth and development, the exposure of a plant to excess volumes of water (“water stress”) can damage the plant. Application of the macrocyclic tetrapyrrole compound, compositions or combinations described herein to a plant prior to the onset of an excess water condition can increase the plant's resistance to the water stress. The macrocyclic tetrapyrrole compound, compositions or combinations described herein can be applied during the water stress, however, dilution of the macrocyclic tetrapyrrole compound, compositions or combinations described herein may occur on account of the excess water. Accordingly, pre-treatment in advance of a period of excess water can be more effective.

It should be noted that what constitutes an excess water stress condition for one plant may not be an excess water stress condition for another plant.

### Synergistic Effect of the Combinations

In some implementations, the combinations can exhibit a synergistic response for increasing resistance or tolerance to one or more abiotic stresses in plants. It should be understood that the terms “synergy” or “synergistic”, as used herein, refer to the interaction of two or more components of a combination (or composition) so that their combined effect is greater than the sum of their individual effects, this may include, in the context of the present description, the action of two or more of the macrocyclic tetrapyrrole agent, the oil and the chelating agent. In some scenarios, the macrocyclic tetrapyrrole agent and the oil can be present in synergistically effective amounts. In some scenarios, the macrocyclic tetrapyrrole agent and the chelating agent can be present in synergistically effective amounts. In some scenarios, the oil and the chelating agent can be present in synergistically effective amounts. In some scenarios, the macrocyclic tetrapyrrole agent, the oil and the chelating agent can be present in synergistically effective amounts.

In some scenarios, the approach as set out in S. R. Colby, “Calculating synergistic and antagonistic responses of herbicide combinations”, Weeds 15, 20-22 (1967), can be used to evaluate synergy. Expected efficacy, E, may be expressed as: E=X+Y(100−X)/100, where X is the efficacy, expressed in % of the untreated control, of a first component of a combination, and Y is the efficacy, expressed in % of the untreated control, of a second component of the combination. The two components are said to be present in synergistically effective amounts when the observed efficacy is higher than the expected efficacy.

### EXAMPLES & EXPERIMENTATION

### Example 1: Effect of Treatments on Primary Root Length of Arabidopsis Seedlings Under Salt Stress

Experiments were conducted to evaluate the effect of metallized chlorin compounds on salt stress treated seedlings, by measuring of primary root length. Copper chlorophyllin (CuChIn) was supplemented to the media onto which Arabidopsis thaliana seeds germinated. It was shown that these plants were more salt tolerant than untreated plants.

Arabidopsis thaliana seeds were surface sterilized in 50% bleach for 12 minutes with shaking and washed five times with sterilized water. The seeds were plated on half-strength Murashige and Skoog (MS) media containing 0.8% agar and 1% sucrose, buffered to pH 5.7 with KOH. For exposure to salt, media was adjusted to contain 100 mM NaCl. For exposure to CuChIn, CuChIn was prepared as a 1 mM stock in water and was added to the media at 10 μM CuChIn final concentration. Seeds were stratified for 2 days at 4° C. in the dark. Arabidopsis seedlings were grown vertically at a temperature of 24±1° C., under LED lights (PAR 24 μmol m⁻²/s⁻¹) and 16 hours:8 hours, light:dark photoperiod.

Salt stress tolerance was measured by determining the reduction of primary root lengths. Root lengths (mm) were measured 10 days after the germination by analysis of pictures with the Image J™ software. The results are summarized in Table 1 below.

TABLE 1
Effect of copper chlorophyllin on primary root lengths
of treated Arabidopsis seedlings under salt stress.

Root length (mm)

| Treatment | 0 mM NaCl | 100 mM NaCl |
|---|---|---|
| 0 μM CuChln | 5.02 ± 0.16 | 2.46 ± 0.16 |
| 10 μM CuChln | 5.05 ± 0.09 | 3.16 ± 0.14 |

The results are expressed as means±standard errors representing 18 to 20 seedlings/condition.

The results showed that the CuChIn supplemented plants were more salt tolerant than untreated plants. The results also showed that application of 10 μM CuChIn did not influence the root length in the control experiment.

### Example 2: Effect of Treatments on Plant Senescence Triggered by Salt Stress

In this example, the effect of metalized chlorin compounds and various additives on Arabidopsis thaliana senescence triggered by salt stress was measured by a visual rating scale reflecting progressive leaf senescence symptoms. In particular, it was shown that CuChIn provided protection against senescence triggered by salt stress. It was also shown that the addition of oil, in particular poly-alpha-olefin (PAO), chelating agents or combinations thereof, further increased the protection.

After prolonged exposure to salt stress, Na⁺ accumulation in the shoot results in cytotoxic effects, whereby the most visible symptom is yellowing, followed by drying of leaves, due to leaf senescence and death. Leaf senescence may be evaluated by visual scoring reflecting progressive leaf senescence symptoms.

TABLE 2A
Visual scoring reflecting progressive leaf senescence symptoms.

| Score | Observation |
|---|---|
| 9 | Normal growth, no leaf symptoms |
| 7 | Nearly normal growth with some leaves and tips yellow |
| | and rolled |
| 4 | Growth severely inhibited, significant yellowing of the |
| | leaves with most leaves rolled |
| 2 | Complete growth arrest with most of the leaves dried |
| | and some plants dead |

this experiment, seeds were sown directly on soil, the pots were watered and placed under a 16 hours:8 hours, light:dark photoperiod, under LED lights (PAR 24 μmol m⁻² s⁻¹), at a temperature of 25° C.±3° C. and 65% relative humidity. After 14 days, seedlings were irrigated with treatments, 24 hours later watered to capacity with 100 mM NaCl, followed by 200 mM NaCl four days later, and finally 300 mM NaCl every 4 four days until the end of the experiment. The formulations and results are presented in Table 2B below. All percentage values in the Table are in wt % of total composition.

TABLE 2B
Effect of copper chlorophyllin and other additives
on plant senescence triggered by salt stress.

| | Ratings at | %* |
|---|---|---|
| Treatment | 14 days | improvement |
| 0.05% CuChln | 4.5 | 28.7 |
| 0.05% CuChln + 0.125% PAO 7395** | 6 | 71.6 |
| 0.125% PAO 7395** | 4 | 14.4 |
| 0.05% CuChln + 0.125% EDTA-Ca | 7 | 100.2 |
| 0.05% CuChln + 5 mM ethylenediamine-N,N′- | 7 | 100.2 |
| disuccinic acid (EDDS) | | |
| 0.05% CuChln + 0.25% Baypure CX100 ™ | 7.5 | 114.5 |
| 0.05% CuChln + 0.5% Baypure DS ™ | 6.5 | 85.9 |
| 0.125% ethylenediaminetetraacetic acid-Ca | 4 | 14.4 |
| (EDTA-Ca) | | |
| 5 mM EDDS | 4 | 14.4 |
| 0.25% Baypure CX100 ™ | 4 | 14.4 |
| 0.05% CuChln + 0.125% EDTA-Ca + 0.125% | 7.5 | 114.5 |
| PAO7395** | | |
| 0.05% CuChln + 0.125% PAO7395** | 7 | 100.2 |
| 0.05% CuChln + 0.25% Baypure CX100 ™ + | 7.5 | 114.5 |
| 0.125% PAO7395** | | |
| Control (untreated) | 3.5 | 0 |

*values are % sensecence improvement relative to untreated control
**PAO7395: (93 wt % PAO 4 cSt + 7 wt % surfactants (mixture of ethoxylated alkyl alcohols and alkyl monoglyceride))

These results showed that CuChIn provides protection against plants senescence triggered by salt stress. The addition of oil or chelator to CuChIn increased the plant protection between 20-70%, while oil and chelators alone did not significantly increase resistance against senescence triggered by salt stress. The results also show a synergistic effect when a combination of CuChIn and oil is applied, and when a combination of CuChIn and chelating agent is applied.

### Example 3: Effect of Treatments on Primary Root Lengths of White Clover (Trifolium repens) seedlings under salt stress.

In this example, the effect of porphyrin compounds on the sensitivity to salt stress of seedlings was evaluated. In particular, the effect of protoporphyrin-IX (PP9), zinc protoporphyrin-IX (ZnPP9) and zinc tetraphenylporphyrin (ZnTPP) treated white clover (Trifolium repens) seedlings under salt stress conditions was evaluated.

White clover (Trifolium repens) seeds were surface sterilized in 50% bleach for 12 minutes with shaking and washed five times with sterilized water. The seeds were germinated in 10 ml of water at room temperature under LED lights (PAR 24 μmol m⁻²/s⁻¹) and 16 hours:8 hours, light:dark photoperiod.

For exposure to salt, the water was adjusted to contain 100 mM NaCl. Porphyrin compounds were prepared as a 0.1% stock in dimethyl sulfoxide (DMSO). Porphyrin compounds were added from the stock to a final concentration of 0.01% v/v for the assay.

Salt stress tolerance was measured by determining the reduction of primary root length by analysis of pictures with the Image J™ software. Root lengths (mm) were measured 7 days after the germination. The following Table 3 summarizes the results.

TABLE 3
Effect of various amino-macrocycles on primary root lengths of
white clover (Trifolium repens) seedlings under salt stress.

| | Root length (mm) | Root length (mm) |
|---|---|---|
| Treatment | 0 mM NaCl | 100 mM NaCl |
| Untreated control | 1.14 ± 0.13 | 0.40 ± 0.007 |
| PP9 | 1.04 ± 0.05 | 0.7 ± 0.08 |
| ZnPP9 | 1.01 ± 0.08 | 0.8 ± 0.08 |
| ZnTPP | 0.97 ± 0.06 | 0.92 ± 0.02 |

Results are expressed as means ± standard errors.
These results showed that all tested porphyrin compounds decrease the sensitivity to salt stress in white clover seedlings.

### Example 4: Effect of Treatments on Kentucky Bluegrass Tolerance to Salt Stress

In this example, the effects of metalized chlorin compounds and formulations were tested on Kentucky bluegrass cultivar “Granit”. The experiments were conducted in a greenhouse. The tests were performed to determine the activity of compounds on grass tolerance to salt stress.

In the experiments, Kentucky bluegrass cultivar “Granit” was seeded in 6-inch plastic pots filled with professional soil mix (Sunshine LC 1, Sun Gro Horticulture Canada Ltd.). The pots were placed in a mist chamber for 7 to 10 days to promote uniform plants emergence and growth, and then maintained in a greenhouse conditions for 4 to 6 weeks. The plants were regularly clipped to 4-5 cm height and irrigated with fertilized water on a regular basis. Kentucky bluegrass plants were treated with one foliar application of different formulations presented in the table below using hand held spray bottle providing an even coverage. 24 hours after the initial spray, the plants were exposed to salinity stress by submerging pots to 170 mM sodium chloride solution until saturation and then transferred on the greenhouse bench. Salting was applied on 5 to 7 days interval within duration of the experiment. During this period, the Kentucky bluegrass was evaluated for salt stress tolerance and rated weekly for turf quality. The turf quality (TQ) was visually rated according to guidance from The National Turfgrass Evaluation Program (NTEP) using a modified scale of 1 to 9 (based on plants vigor, color, senescence, density, leaf texture and size and uniformity). Plants rated 1 were completely desiccated with a completely dead turf canopy. A rating of 9 represented healthy plants with dark green, turgid leaf blades and a dense turf canopy. A rating of 6 was considered the minimal acceptable TQS (Turf Quality Score). Untreated stress control (Salt control) was used as a reference for each rating respectively. The experiment was conducted using a completely randomized design with four replications for each treatment. The results are summarized in Tables 4A, 4B and 4C below.

TABLE 4A
Effect of copper chlorophyllin and various oils on
Kentucky bluegrass tolerance to salt stress. Turf
Quality Score, rating scale 1-9 (Initial score: 8).

| | | Turf Quality Score/ | | | |
|---|---|---|---|---|---|
| | | day after treatment (DAT) | | | |
| | | 24 DAT | | 30 DAT | |
| | | | % | | % |
| # | Treatment | TQS | increase | TQS | increase |
| 1 | Salt stress Control | 3.0 | 0 | 2.0 | 0 |
| 2 | CuChln 0.1% + 0.07% | 5.1 | 70 | 3.8 | 90 |
| | surfactant* | | | | |
| 3 | CuChln 0.1% + PAO 2 cSt | 6.8 | 127 | 5.3 | 165 |
| | 0.93% + 0.07% surfactant* | | | | |
| 4 | CuChln 0.1% + PAO 4 cSt | 6.3 | 110 | 4.4 | 120 |
| | 0.93% + 0.07% surfactant* | | | | |
| 5 | CuChln 0.1% + PAO 6 cSt | 6.3 | 110 | 4.5 | 125 |
| | 0.93% + 0.07% surfactant* | | | | |
| 6 | CuChln 0.1% + PAO 8 cSt | 6.4 | 113 | 4.5 | 125 |
| | 0.93% + 0.07% surfactant* | | | | |
| 7 | CuChln 0.1% + MCT Coconut oil | 6.0 | 100 | 4.5 | 125 |
| | 0.93% + 0.07% surfactant* | | | | |
| 8 | CuChln 0.1% + Canola oil | 6.1 | 103 | 3.8 | 90 |
| | 0.93% + 0.07% surfactant* | | | | |
| 9 | CuChln 0.1% + Peanut oil | 5.3 | 77 | 4.3 | 115 |
| | 0.93% + 0.07% surfactant* | | | | |
| 10 | CuChln 0.1% + N65DW | 6.5 | 117 | 5.3 | 165 |
| | 0.93% + 0.07% surfactant* | | | | |

*Surfactant: (mixture of 60% ethoxylated alkyl alcohols and 40% alkyl monoglyceride).

The results showed that various vegetable oil and various mineral oils may be used to increase the effect of copper chlorophyllin and enhance Kentucky bluegrass tolerance to salt stress.

TABLE 4B
Effect of treatments on Kentucky bluegrass tolerance to salt stress.
Turf Quality Score, rating scale 1-9 (Initial score: 8).

| | | Turf Quality Score/ | | | |
|---|---|---|---|---|---|
| | | day after treatment (DAT) | | | |
| | | 19 DAT | | 26 DAT | |
| | | | % | | % |
| # | Treatment | TQS | increase | TQS | increase |
| 1 | Salt Stress Control | 3.3 | 0 | 2.6 | 0 |
| 2 | CuChln isopropylamine salt | 5.8 | 76 | 5.3 | 104 |
| | 0.1% + 1% PAO7395* | | | | |
| 3 | CuChln triethanolamine salt | 3.5 | 6 | 4.4 | 69 |
| | 0.1% + 1% PAO7395* | | | | |
| 4 | CuChln triethylamine salt | 4.9 | 48 | 4.5 | 73 |
| | 0.1% + 1% PAO7395* | | | | |
| 5 | CuChln ammonium hydroxide | 4.0 | 21 | 4.3 | 65 |
| | salt 0.1% + 1% PAO7395* | | | | |
| 6 | CuChln tetrabutylammonium | 5.3 | 61 | 3.8 | 46 |
| | hydroxide salt 0.1% + | | | | |
| | 1% PAO7395* | | | | |
| 7 | CuChln hexamine salt 0.1% + | 5.0 | 52 | 5.6 | 115 |
| | 1% PAO7395* | | | | |
| 8 | CuChln sodium salt 0.1% + | 5.8 | 76 | 5.5 | 112 |
| | 1% PAO7395* | | | | |
| 9 | MgChln sodium salt 0.1% + | 5.6 | 70 | 4.3 | 65 |
| | 1% PAO7395* | | | | |
| 10 | PAO 7395* 1% | 3.8 | 15 | 3.9 | 50 |

*PAO7395 = 93% PAO 4 cSt + 7% surfactants (mixture of 60% ethoxylated alkyl alcohols and 40% alkyl monoglyceride)

The results show that various metalized chlorophyllins may be used with mineral oil to enhance Kentucky bluegrass tolerance to salt stress.

TABLE 4C
Effect of treatments on Kentucky bluegrass tolerance to salt stress.
Turf Quality Score, rating scale 1-9 (Initial score: 8).

| | | Turf Quality Score/ | | | |
|---|---|---|---|---|---|
| | | day after treatment (DAT) | | | |
| | | 23 DAT | | 29 DAT | |
| | | | % | | % |
| # | Treatment | TQS | increase | TQS | increase |
| 1 | Salt stress Control | 1.9 | 0 | 1 | 0 |
| 2 | CuChln isopropylamine salt | 6.6 | 247 | 6 | 500 |
| | 0.1% + PAO 7395* 1% | | | | |
| 3 | CuChln tetrabutylammonium | 6.5 | 242 | 5.6 | 460 |
| | hydroxide salt 0.1% + | | | | |
| | PAO7395* 1% | | | | |
| 4 | CuChln hexamine salt 0.1% + | 5.8 | 205 | 3.5 | 250 |
| | PAO 7395* 1% | | | | |
| 5 | NiChln 0.05% + PAO 7395* 1% | 4.9 | 158 | 2.1 | 110 |
| 6 | CuChln 0.1% + PAO 7395* 1% | 7.1 | 274 | 5.6 | 460 |
| 7 | PAO 7395* 1% | 5.9 | 211 | 2.6 | 160 |
| 8 | CuChln 0.1% + 0.1% surfactant | 4.5 | 137 | 1.0 | 0 |
| | 80** | | | | |
| 9 | CuChln 0.1% + 0.1% surfactant | 3.5 | 84 | 1.0 | 0 |
| | 3273*** | | | | |
| 10 | CuChln 0.1% + 0.5% PAO 4 cst + | 5.8 | 205 | 3.0 | 200 |
| | 0.5% surfactant 3273*** | | | | |
| 11 | CuChln 0.1% + 0.1% surfactant | 1.0 | 0 | 1.0 | 0 |
| | 3273*** + 0.5% PVP-40 | | | | |
| 12 | CuChln 0.1% + 0.1% surfactant | 2.0 | 5 | 1.0 | 0 |
| | 3273*** + 0.5% PVP-40 | | | | |
| 13 | 0.1% CuChln acid 0.1% grinded | 6.8 | 258 | 5.9 | 490 |
| | with 3 eq. hexamine + PAO | | | | |
| | 7395* 1% | | | | |

*PAO7395 = 93% PAO 4 cSt + 7% surfactants (mixture of 60% ethoxylated alkyl alcohols and 40% alkyl monoglyceride);
surfactant 80** = Ethoxylated sorbitan trioleate;
surfactant 3273*** = mixture of 60% ethoxylated alkyl alcohols and 40% alkyl monoglyceride

The results show that various metalized chlorophyllins may be used with mineral oil to increase Kentucky bluegrass tolerance to salt stress.

### Example 5: Effect of Treatments on Strawberry Plants (Fragaria x ananassa) Tolerance to Salt Stress

In this example, the effects of chlorin compounds and formulations were tested on strawberry plants (Fragaria x ananassa) cv Basket Pink. The experiments were carried out in a greenhouse. Tests were designed to determine the activity of compounds on strawberry plants tolerance to salt stress.

In the experiments, seedlings of strawberry plants were grown in 5-inch plastic pots filled with professional soil mix (Sunshine LC 1, Sun Gro Horticulture Canada Ltd.) and irrigated with fertilized water on a regular basis. The strawberry plants at 4-5 leaf stage were treated with 4 foliar applications of different formulations using hand hold Spray bottle providing an even coverage. The plants were sprayed every 7 days. 24 hours after the initial spray, the plants were exposed to salinity stress by watering them with 25 mM sodium chloride solution. The salinity level was gradually increased to 50 mM NaCl and salt solution was applied on a 5 to 7 days interval schedule. The experiment was set out in a completely randomized design with four replications for each treatment. The results are summarized in Table 5 below.

TABLE 5
Effect of treatments on strawberry plants
(Fragaria × ananassa) tolerance to salt stress.

| | | Above ground biomass, g/*plant⁻¹ | | | |
|---|---|---|---|---|---|
| | | Fresh weight | | Dry weight | |
| | | g/ | % | g/ | % |
| # | Treatment | plant | increase | plant | increase |
| 1 | Salt Stress Control | 3.01 | 0 | 1.62 | 0 |
| 2 | CuChln 0.1% + PAO*0.5% | 3.86 | 28 | 1.81 | 12 |
| 3 | CuChln 0.2% + PAO* 0.5% | 4.38 | 46 | 2.05 | 27 |
| 4 | CuChln 0.1% + PAO* 0.5% + | 4.26 | 42 | 2.03 | 25 |
| | Ca₂EDTA 0.05% | | | | |
| 5 | MgChln 0.1% + PAO* 0.5% | 4.23 | 41 | 1.81 | 12 |
| 6 | MgChln 0.1% + PAO* 0.5% + | 4.16 | 38 | 1.84 | 14 |
| | Ca₂EDTA 0.05% | | | | |

*PAO = 93% PAO 4 cSt + 7% surfactants (mixture of 30% ethoxylated alkyl alcohols, 20% alkyl monoglyceride and 50% ethoxylated sorbitan oleates).

Foliar applications of the treatments resulted in higher plants biomass accumulation and enhanced strawberry plants tolerance to salt stress.

### Example 6: Effect of Treatments on the Pigment Content Under Photooxidative Conditions

In this example, the effect of chlorin compounds on the pigment content of seedlings grown under photooxidative conditions was evaluated. In particular, the effect of CuChIn on the pigment content of Arabidopsis seedlings grown under photooxidative conditions was evaluated. To do so, the pigments were extracted and quantified. It was shown that CuChIn supplemented plants retained more pigments under this type of stress.

Exposure of Arabidopsis thaliana to photooxidative conditions resulted in a progressive decline in pigment content. In this experiment, to determine the effect of CuChIn on the pigment content, seedlings were grown as in Example 1, except that the plants were transferred under LED lights (PAR 142 μmol m⁻² s⁻¹) one week after germination. 14 days old seedlings were then harvested and weighted. The tissue was ground in liquid nitrogen. Pigments were extracted in 100% methanol at a temperature of 4° C. overnight. The pigment concentrations were determined spectrophotometrically and calculated using the following formulas known to those skilled in the art (i.e. Sumanta et al., 2014):Ch−a=16.72A_{665.2}−9.16A_{652.} (for chlorophyll a); Ch−b=34.09A_{652.}−15.28A₆₆₅ (for chlorophyll b); C x+c=(1000A₄₇₀−1.63Ca−104.96Cb)/221 (for carotenoids) and A₅₃₀−(¼×A₆₅₇) (for anthocyanins) (A=absorbance). The results are summarized in Table 6 below. The data is expressed as means±standard error.

TABLE 6
Effect of copper chlorophyllin on the pigment
content under photooxidative conditions.

| Pigments | Untreated control | 20 μM CuChln |
|---|---|---|
| Ch-a (μg/ml) | 1.65 ± 0.7 | 6.62 ± 0.8 |
| Ch-b (μg/ml) | 1.62 ± 0.31 | 2.28 ± 0.14 |
| Cx + c (carotenoids) (μg/ml) | 0.21 ± 0.35 | 1.56 ± 0.25 |
| Anthocyanins (μg/ml) | 0.06 ± 0.01 | 0.08 ± 0.05 |

These results showed that CuChIn treated plants retain more pigments than untreated plants, under photooxidative conditions.

### Example 7: Effect of Treatments on Kentucky Bluegrass Tolerance to Drought Stress

In this example, the effects of chlorine compounds and formulations were tested on Kentucky bluegrass plants (cv. ‘Wildhorse’). Tests were designed to determine the activity of compounds on Kentucky bluegrass (cv. Wildhorse') tolerance to drought stress.

In the experiments, mature Kentucky bluegrass (cv. ‘Wildhorse’) plugs (10 cm diameter, 5 cm deep) were collected from the field plots and transplanted into pots (15 cm diameter, 14 cm deep, with 8 holes in the bottom) filled with USGA-specification sand with 10% peat. A piece of plastic screen was placed in the bottom of the pot to prevent sand from leaching. The grass was grown in growth chamber at a temperature of 22° C. during daytime and 18° C. during nighttime, 70% relative humidity, LED lights (PAR 400 μmol m⁻² s⁻¹) and 12 hours photoperiod. Nitrogen was applied at 2 g m⁻² (0.4 lbs N/1000 ft²) (28-8-18 complete fertilizer with micronutrients N-P-K) at the transplanting time and then 1 g m⁻² biweekly until the end of the trial. The grass was clipped at 7 cm, and irrigated two times a week to field capacity.

The grass was subjected to two soil moisture levels: no drought (no stress control, well-watered—WW) and deficit irrigation (drought) initiated 24 hours after 1^{st} application. The amount of irrigation water was determined based on evapotranspiration (ET) loss by weighing the pots every other day and the irrigation was provided to compensate 50% to 25% ET loss. The experiments were completed 28 days after stress induction. Leaf samples were collected at 0, 4 (3 days of stress), 7, 14, 21, and 28 days, frozen with liquid N and stored at −80° C. for analysis of metabolite content. Physiological measurements took place at the same time as regular sampling.

Experimental design was a completely randomized block design with 4 replications. Additional two applications were included to be used for sampling.

Data were analyzed with analysis of variance and separation of means was performed with a Fisher's protected least significant difference (LSD) test at a 0.05 probability level (SAS Institute, 2010). The results are summarized in Tables 7A to 7H below.

TABLE 7A
Four weeks after transplanting, treatments
were applied to foliage as follows:

| | Soil | Formulation spray | Application |
|---|---|---|---|
| Treatment | moisture | solution (mL/pot) | time |
| 1 | Well- | 0 | Control |
| | watered | | |
| 2 | Well- | 8.0 (A: CuChln 0.11% + | 2 applications |
| | watered | B: PAO* 1%) | (day 0, 14) |
| 3 | Drought | 0 | 0 |
| 4 | Drought | 8.0 (A: CuChln 0.11% + | 1 application |
| | | B: PAO* 1%) | (day 0) |
| 5 | Drought | 8.0 (A: CuChln 0.11% + | 2 applications |
| | | B: PAO* 1%) | (day 0, 14) |
| 6 | Drought | 8.0 (A: CuChln 0.22% + | 1 application |
| | | B: PAO* 1%) | (day 0) |
| 7 | Drought | 8.0 (C: MgChl 0.11% + | 1 application |
| | | B: PAO* 1%) | (day 0) |

*PAO = 93% PAO 4 cSt + 7% surfactants (mixture of ethoxylated alkyl alcohols and alkyl monoglyceride)

TABLE 7B
Effect of treatments on Kentucky bluegrass response to drought
stress. Well-watered (WW) and drought stress conditions.

| | | | Turf Quality Score (1-9)/day after treatment (DAT) | | | | | |
|---|---|---|---|---|---|---|---|---|
| | | | 14 DAT | | 21 DAT | | 28 DAT | |
| Stress | | | | % | | % | | % |
| level | Treatment | Rate | TQS | increase | TQS | increase | TQS | increase |
| WW | Control | 0 | 7.5 | 0 | 7.0 | 0 | 7.0 | 0 |
| WW | A + B (2 app) | 0.11% + 1% | 7.9 | 5.3 | 7.9 | 13 | 8 | 7 |
| Drought | Control | 0 | 7.1 | 0 | 6.0 | 0 | 4.5 | 0 |
| Drought | A + B (1 app) | 0.11% + 1% | 8.0 | 13 | 7.4 | 23 | 5.3 | 18 |
| Drought | A + B (2 app) | 0.11% + 1% | 7.5 | 6 | 7.0 | 17 | 5.9 | 31 |
| Drought | A + B (1 app) | 0.22% + 1% | 8.0 | 13 | 7.4 | 23 | 5.8 | 29 |
| Drought | C + B (1 app) | 0.11% + 1% | 7.8 | 10 | 6.9 | 15 | 5.8 | 29 |

TABLE 7C
Kentucky bluegrass leaf relative water content
(RWC). Plant response to treatments under well-
watered (WW) and drought stress conditions.

| Stress | | | RWC % | RWC % | RWC % |
|---|---|---|---|---|---|
| level | Treatment | Rate | 14 DAT | 21 DAT | 28 DAT |
| WW | Control | 0 | 79.9 | 79.0 | 80.7 |
| WW | A + B (2 app) | 0.11% + 1% | 80.8 | 81.0 | 81.2 |
| Drought | Control | 0 | 71.9 | 67.6 | 59.4 |
| Drought | A + B (1 app) | 0.11% + 1% | 75.9 | 72.1 | 64.0 |
| Drought | A + B (2 app) | 0.11% + 1% | 74.8 | 71.8 | 64.3 |
| Drought | A + B (1 app) | 0.22% + 1% | 76.3 | 72.6 | 65.0 |
| Drought | C + B (1 app) | 0.11% + 1% | 75.8 | 70.5 | 63.9 |

TABLE 7D
Kentucky bluegrass leaf electrolyte leakage (EL). Plant response to
treatments under well-watered (WW) and drought stress conditions

| Soil | | | EL (%) | EL (%) | EL (%) |
|---|---|---|---|---|---|
| moisture | Treatment | Rate | 14 DAT | 21 DAT | 28 DAT |
| WW | Control | 0 | 22.4 | 24.1 | 24.6 |
| WW | A + B (2 app) | 0.11% + 1% | 22.8 | 21.3 | 21.2 |
| Drought | Control | 0 | 39.2 | 53.5 | 60.0 |
| Drought | A + B (1 app) | 0.11% + 1% | 37.0 | 45.9 | 50.4 |
| Drought | A + B (2 app) | 0.11% + 1% | 37.4 | 43.2 | 49.5 |
| Drought | A + B (1 app) | 0.22% + 1% | 38.5 | 44.7 | 49.1 |
| Drought | C + B (1 app) | 0.11% + 1% | 36.6 | 45.9 | 48.2 |

TABLE 7E
Kentucky bluegrass leaf chlorophyll (Chl) content. Plant response to
treatments under well-watered (WW) and drought stress conditions.

| | | | Chl | Chl | Chl |
|---|---|---|---|---|---|
| | | | (mg g⁻¹ | (mg g⁻¹ | (mg g⁻¹ |
| Soil | | | FW) | FW) | FW) |
| moisture | Treatment | Rate | 14 DAT | 21 DAT | 28 DAT |
| WW | Control | 0 | 1.54 | 1.58 | 1.71 |
| WW | A + B (2 app) | 0.11% + 1% | 1.87 | 1.73 | 2.01 |
| Drought | Control | 0 | 1.42 | 1.43 | 1.42 |
| Drought | A + B (1 app) | 0.11% + 1% | 1.66 | 1.63 | 1.54 |
| Drought | A + B (2 app) | 0.11% + 1% | 1.51 | 1.63 | 1.61 |
| Drought | A + B (1 app) | 0.22% + 1% | 1.69 | 1.67 | 1.67 |
| Drought | C + B (1 app) | 0.11% + 1% | 1.59 | 1.60 | 1.60 |

TABLE 7F
Kentucky bluegrass leaf carotenoids content. Plant response to treatments
under well-watered (WW) and drought stress conditions.

| | | | Caro | Caro | Caro |
|---|---|---|---|---|---|
| | | | (mg g⁻¹ | (mg g⁻¹ | (mg g⁻¹ |
| Soil | | | FW) | FW) | FW) |
| moisture | Treatment | Rate | 14 DAT | 21 DAT | 28 DAT |
| WW | Control | 0 | 0.39 | 0.39 | 0.43 |
| WW | A + B (2 app) | 0.11% + 1% | 0.47 | 0.43 | 0.50 |
| Drought | Control | 0 | 0.36 | 0.36 | 0.36 |
| Drought | A + B (1 app) | 0.11% + 1% | 0.42 | 0.41 | 0.39 |
| Drought | A + B (2 app) | 0.11% + 1% | 0.38 | 0.39 | 0.38 |
| Drought | A + B (1 app) | 0.22% + 1% | 0.42 | 0.42 | 0.42 |
| Drought | C + B (1 app) | 0.11% + 1% | 0.40 | 0.40 | 0.40 |

TABLE 7G
Leaf catalase (CAT) activity response to treatments in Kentucky
bluegrass under well-watered (WW) and drought stress conditions.

| | | | CAT | CAT | CAT |
|---|---|---|---|---|---|
| | | | (nmol | (nmol | (nmol |
| | | | g⁻¹ FW | g⁻¹ FW | g⁻¹ FW |
| Stress | | | min⁻¹) | min⁻¹) | min⁻¹) |
| level | Treatment | Rate | 14 DAT | 21 DAT | 28 DAT |
| WW | Control | 0 | 0.58 | 0.54 | 0.53 |
| WW | A + B (2 app) | 0.11% + 1% | 0.61 | 0.51 | 0.55 |
| Drought | Control | 0 | 0.32 | 0.41 | 0.38 |
| Drought | A + B (1 app) | 0.11% + 1% | 0.44 | 0.83 | 0.59 |
| Drought | A + B (2 app) | 0.11% + 1% | 0.43 | 0.63 | 0.85 |
| Drought | A + B (1 app) | 0.22% + 1% | 0.42 | 0.69 | 0.81 |
| Drought | C + B (1 app) | 0.11% + 1% | 0.53 | 0.63 | 0.62 |

TABLE 7H
Kentucky bluegrass leaf proline content. Plant response to treatments
under well-watered (WW) and drought stress conditions.

| | | | Proline | Proline | Proline |
|---|---|---|---|---|---|
| | | | (μg g⁻¹ | (μg g⁻¹ | (μg g⁻¹ |
| Soil | | | FW) | FW) | FW) |
| moisture | Treatment | Rate | 14 DAT | 21 DAT | 28 DAT |
| WW | Control | 0 | 246.4 | 263.7 | 291.1 |
| WW | A + B (2 app) | 0.11% + 1% | 268.8 | 293.9 | 303.7 |
| Drought | Control | 0 | 461.6 | 471.5 | 807.4 |
| Drought | A + B (1 app) | 0.11% + 1% | 479.3 | 653.1 | 900.3 |
| Drought | A + B (2 app) | 0.11% + 1% | 484.4 | 655.9 | 895.0 |
| Drought | A + B (1 app) | 0.22% + 1% | 509.1 | 691.5 | 878.6 |
| Drought | C + B (1 app) | 0.11% + 1% | 508.3 | 540.8 | 905.0 |

### Example 8: Effect of Treatments on Strawberry Plants (Fragaria x ananassa) Tolerance to Drought Stress

In this example, the effects of chlorophyllin compounds and formulations were tested on strawberry plants (Fragaria x ananassa) cv Basket Pink. The experiments were carried out in a greenhouse. Tests were designed to determine the activity of compounds on strawberry plants tolerance to drought stress.

In the experiments, seedlings of strawberry plants were grown in 5-inch plastic pots filled with professional soil mix (Sunshine LC 1, Sun Gro Horticulture Canada Ltd.) and irrigated with fertilized water on a regular basis. Strawberry plants at 4-5 leaf stage were treated with 4 foliar applications of different Suncor formulations using hand hold Spray bottle providing an even coverage. The plants were sprayed every 7 days. After first foliar treatment and during the experiment duration, strawberry plants were exposed to reduced water regime (drought stress) until the wilting point (20 to 30% soil moisture capacity—SMC) and watered up to 50% SMC. At the time of intensive fruiting, plants were watered to 50-60% SMC. The experiment was set out in a completely randomized design with five replications for each treatment.

TABLE 8
Effect of treatments on strawberry fruit yield and growth parameters (Number of applications: 4)

| | | Above ground biomass, g/plant⁻¹ | | | | Root, g/plant⁻¹ | | Yield, g/plant⁻¹ | | | |
|---|---|---|---|---|---|---|---|---|---|---|---|
| | | Fresh weight | | Dry weight | | Dry weight | | Red fruit | | Red and green fruit | |
| | | g | % | g | % | g | % | g | % | g | % |
| # | Treatment | plant⁻¹ | increase | plant⁻¹ | increase | plant⁻¹ | increase | plant⁻¹ | increase | plant⁻¹ | increase |
| 1 | CuChln 0.1% + PAO 488* 0.5% | 40.66 | 15 | 13.62 | 12 | 1.07 | 0 | 25.44 | 121 | 27.29 | 53 |
| 2 | CuChln 0.2% + PAO 488* 0.5% | 34.00 | 0 | 12.75 | 5 | 1.41 | 27 | 28.59 | 149 | 32.36 | 81 |
| 3 | CuChln 0.1% + PAO 488*0.5% + | 42.65 | 21 | 14.37 | 18 | 1.21 | 9 | 25.96 | 126 | 28.24 | 58 |
| | Ca₂EDTA 0.05% | | | | | | | | | | |
| 4 | MgChl 0.1% + PAO 488* 0.5% | 37.27 | 6 | 13.61 | 12 | 1.15 | 3 | 38.42 | 234 | 41.77 | 134 |
| 5 | MgChl 0.1% + PAO 488* 0.5% + | 42.55 | 21 | 13.56 | 11 | 1.63 | 47 | 45.69 | 298 | 53.66 | 201 |
| | Ca₂EDTA 0.05% | | | | | | | | | | |
| 6 | Drought Control | 35.22 | 0 | 12.17 | 0 | 1.11 | 0 | 11.49 | 0 | 17.83 | 0 |

*PAO 488 = 93% PAO 4 cSt + 7% Surfactants (mixture of 30% ethoxylated alkyl alcohols, 20% alkyl monoglyceride and 50% ethoxylated sorbitan oleates)

Treatment foliar applications enhanced strawberry plant tolerance to prolonged drought stress, boosted plants biomass production and increased yield.

### Example 9: Effect of Treatments on Tomato Plants Tolerance to Drought Stress

In this example, the effects of chlorin compounds and formulations were tested on tomato plants cv. Tumbling Tom. The experiments were carried out in a greenhouse. Tests were designed to determine the activity of compounds on tomato plants tolerance to drought stress.

In the experiments, tomato plants cv. Tumbling Tom were transplanted to 1 gal pots containing industrial soil mix LC1(Sunshine LC 1, Sun Gro Horticulture Canada Ltd.) At 4 to 5 leaves stage, plants were treated (foliar spray to run-off) with tested solutions and exposed to prolonged drought stress during the growing period. Foliar treatments were applied 3 times with 7 days interval. 5 replications per treatment were used.

TABLE 9A
Effect of treatments on tomato plants tolerance to drought stress.

| | | | | Fruit, plant⁻¹ | | | | | | | |
|---|---|---|---|---|---|---|---|---|---|---|---|
| | Plant Biomass, g/plant⁻¹ | | | Red fruit | | | Green fruit | | | Total fruit (red + green) | |
| | Fresh weight, g | Dry weight, g | | | Weight, | % | | Weight, | % | Weight, | % |
| Treatments | Shoots | Shoots | Roots | Number | g | Increase* | Number | g | Increase* | g | Increase* |
| Watered Control | 191.01 | 19.18 | 1.33 | 5.6 | 25.5 | 47 | 21.6 | 170.76 | 199 | 196.26 | 204 |
| Untreated | 124.84 | 14.85 | 0.92 | 3.8 | 17.32 | 0 | 8.2 | 57.17 | 0 | 64.30 | 0 |
| Drought Control | | | | | | | | | | | |
| CuChln (0.11%) + | 169.03 | 18.64 | 1.06 | 7.6 | 34.26 | 98 | 10.6 | 74.98 | 31 | 109.24 | 70 |
| 0.93% N65DW** + | | | | | | | | | | | |
| 0.07% Surfactants*** | | | | | | | | | | | |

Fruit Weight Increase*: vs untreated drought control
N65DW** = paraffinic oil
Surfactants*** = mixture of 30% ethoxylated alkyl alcohols, 20% alkyl monoglyceride and 50% ethoxylated sorbitan oleates

TABLE 9B
Effect of treatments on tomato plants tolerance to prolonged drought stress
(application: soil drench 20 ml/cell-3 times with 7 days interval).

| | | | Above ground plant biomass, g/plant⁻¹ | | | |
|---|---|---|---|---|---|---|
| | | | Fr. | % | Dry | % |
| # | Treatment | Rate, % | weight | increase | weight | increase |
| 1 | Drought Control | | 4.82 | 0 | 0.72 | 0 |
| 2 | CuChln + PAO 488* | 0.1 + 0.5 | 5.17 | 7 | 0.76 | 5 |
| 3 | MgChln + PAO 488* | 0.1 + 0.5 | 5.70 | 18 | 0.84 | 17 |

*PAO488 = 93% PAO 4 cSt + 7% surfactants (mixture of 30% ethoxylated alkyl alcohols, 20% alkyl monoglyceride and 50% ethoxylated sorbitan oleates)

TABLE 9C
Effect of treatments on tomato plants tolerance to prolonged drought
stress (application: foliar spray - 3 times with 7 days interval).

| | | | Above ground plant biomass, g/plant⁻¹ | | | | |
|---|---|---|---|---|---|---|---|
| | | | Shoots Fr. | % | Shoots Dry | % | Plant vigor |
| # | Treatment | Rate, % | weight, g | increase | weight, g | increase | Score 1-5 |
| 1 | Drought Control | | 6.7 | 0 | 0.81 | 0 | 3.8 |
| 2 | CuChln | 0.1 | 8.7 | 29.6 | 0.84 | 4 | 4.6 |
| 3 | PAO488* + CuChln | 0.5 + 0.1 | 7.6 | 12.5 | 0.92 | 14 | 3.7 |

*PAO488 = 93% PAO 4 cSt + 7% surfactants (mixture of 30% ethoxylated alkyl alcohols, 20% alkyl monoglyceride and 50% ethoxylated sorbitan oleates)

### Example 10: Effect of Multiple Foliar Applications of Treatments on Tomato Plants Tolerance to Prolonged Drought Stress

In this example, the effects of chlorin compounds and formulations were tested on tomato plants cv. Tumbling Tom. The experiments were carried out in a greenhouse. Tests were designed to determine the activity of compounds on tomato plants tolerance to prolonged drought stress.

Tomato transplants were grown in 6″ pots to 5-6 leaves stage. Plants were divided into 4 groups and treated 1 time, 2 times, 3 times and four times with 7 days interval. After the first foliar treatment, tomato plants were subjected to prolonged drought stress. 6 weeks after first treatment, plants were harvested, and dry plant weights were recorded.

TABLE 10
Effect of multiple foliar applications of treatments on
tomato plant tolerance to prolonged drought stress.

| Treatment | | Shoot Dry biomass, | |
|---|---|---|---|
| | Applications | g/plant⁻¹ | |
| | number | g | % increase |
| Drought Control | | 7.17 | 0 |
| CuChln 0.11% + PAO 7395* 0.5% | 1 | 7.84 | 9 |
| CuChln 0.11% + PAO 7395*0.5% | 2 | 8.83 | 23 |
| CuChln 0.11% + PAO 7395 *0.5% | 3 | 8.86 | 24 |
| CuChln 0.11% + PAO 7395*0.5% | 4 | 8.77 | 22 |

*PAO7395 = 93% PAO 4 cst + 7% surfactants (mixture of 60% ethoxylated alkyl alcohols and 40% alkyl monoglyceride).

It was shown that 2 to 4 foliar applications of the CuChIn 0.11%+PAO 7395*0.5% formulation increased tomato plants biomass.

### Example 11: Effect of Treatments on Kentucky Bluegrass Tolerance to Heat Stress

In this example, the effects of chlorin compounds and formulations were tested on Kentucky bluegrass cultivar “Granit”. The experiments were conducted in a greenhouse. The tests were designed to determine the activity of compounds on grass tolerance to heat stress.

In the experiments, Kentucky bluegrass cultivar “Granit” was seeded in 6′ plastic pots filled with professional soil mix (Sunshine LC 1, Sun Gro Horticulture Canada Ltd.). Pots were placed in a mist chamber for 7 to 10 days to promote uniform plants emergence and growth, and then maintained in a greenhouse for 4 to 6 weeks. Plants were regularly clipped to a 4-5 cm height and irrigated with fertilized water on a regular basis. The Kentucky bluegrass plants were treated with one foliar application of different Suncor formulations providing an even coverage using hand hold Spray bottle. 24 hours after the foliar spray, the plants were placed into a growth chamber and exposed to heat stress. The growth chamber was set at 28° C. (16-h day/8-h night photoperiod, PAR at 350 μmol·m⁻² s⁻¹) and 75% humidity. Every day during the day time plants were gradually exposed to heat stress at 36° C. for 8 hours. The Kentucky bluegrass plants were regularly watered to avoid water deficit. The Kentucky bluegrass was evaluated for heat stress tolerance by rating weekly for turf quality. Grass was visually rated for Turf Quality using a modified NTEP Turfgrass Evaluation Guidelines, scale 1 to 9 based on plants vigor, color, senescence, density, leaf blades size. Turf rated 1 was completely desiccated with a completely dead turf canopy. A rating of 9 represented healthy plants with dark green, turgid leaf blades and a healthy turf canopy. A rating of 6 was considered the minimal acceptable TQ. Untreated heat stress control (Heat control) was used as a reference for each rating respectively. The experiment was set out in a completely randomized design with four replications for each treatment.

TABLE 11A
Effect of treatments on Kentucky bluegrass tolerance to Heat stress.
Turf Quality Score, rating scale 1-9 (Initial score: 8).

| | | Turf Quality Score/ | | | |
|---|---|---|---|---|---|
| | | day after treatment (DAT) | | | |
| | | 24 DAT | | 30 DAT | |
| | | | % | | % |
| # | Treatment | TQS | increase | TQS | increase |
| 1 | Heat stress Control | 4.8 | 0 | 4.3 | 0 |
| 2 | CuChln 0.1% + 0.07% | 4.1 | 0 | 5.0 | 16 |
| | surfactant** | | | | |
| 3 | CuChln 0.1% + PAO 2 cst | 4.3 | 0 | 5.8 | 35 |
| | 0.93% + 0.07% surfactant** | | | | |
| 4 | CuChln 0.1% + PAO 4 cst | 7.0 | 46 | 6.5 | 51 |
| | 0.93% + 0.07% surfactant** | | | | |
| 5 | CuChln 0.1% + PAO 6 cst | 6.8 | 42 | 6.1 | 42 |
| | 0.93% + 0.07% surfactant** | | | | |
| 6 | CuChln 0.1% + PAO 8 cst | 6.1 | 27 | 6.3 | 47 |
| | 0.93% + 0.07% surfactant** | | | | |
| 7 | CuChln 0.1% + MCT coconut oil | 5.3 | 10 | 5.0 | 16 |
| | 0.93% + 0.07% surfactant** | | | | |
| 8 | CuChln 0.1% + canola oil | 5.4 | 13 | 5.4 | 26 |
| | 0.93% + 0.07% surfactant** | | | | |
| 9 | CuChln 0.1% + peanut oil | 5.8 | 21 | 5.9 | 37 |
| | 0.93% + 0.07% surfactnat** | | | | |
| 10 | CuChln 0.1% + N65DW* | 6.4 | 33 | 6.1 | 42 |
| | 0.93% + 0.07% surfactant** | | | | |

N65DW* = paraffinic oil
Surfactant** = mixture of 30% ethoxylated alkyl alcohols, 20% alkyl monoglyceride and 50% ethoxylated sorbitan oleates

TABLE 11B
Effect of treatments on Kentucky bluegrass tolerance to heat stress.
Turf Quality Score, rating scale 1-9 (Initial score: 8).

| | | Turf Quality Score/ | |
|---|---|---|---|
| | | day after treatment (DAT) | |
| # | Treatment | 26 DAT | % increase |
| 1 | Heat stress Control | 5.1 | 0 |
| 2 | 0.1% CuChln triethylamine | 6.8 | 33 |
| | salt + 1% PAO7395* | | |
| 3 | 0.1% CuChln ammonium hydroxide | 5.6 | 10 |
| | salt + 1% PAO7395* | | |
| 4 | 0.1% CuChln tetrabutylammonium | 3.5 | 0 |
| | hydroxide salt + 1% PAO7395* | | |
| 5 | 0.1% CuChlnhexamine salt + | 6.3 | 24 |
| | 1% PAO7395* | | |
| 6 | 0.1% CuChln sodium salt + | 6.4 | 25 |
| | 1% PAO7395* | | |
| 7 | 0.1% MgChln sodium salt + | 5.9 | 16 |
| | 1% PAO7395* | | |
| 8 | 1% PAO 7395* | 5.8 | 14 |

*PAO7395 = 93% PAO 4 cst + 7% surfactants (mixture of 60% ethoxylated alkyl alcohols and 40% alkyl monoglyceride).

TABLE 11C
Effect of treatments on Kentucky bluegrass tolerance to heat stress.
Turf Quality Score, rating scale 1-9 (Initial score: 8).

| | | Turf Quality Score/ | | | |
|---|---|---|---|---|---|
| | | day after treatment (DAT) | | | |
| | | 29 | % | 37 | % |
| # | Treatment | DAT | increase | DAT | increase |
| 1 | Heat stress Control | 4 | 0 | 2.3 | 0 |
| 2 | 0.1% CuChln isopropylamine | 6 | 50 | 3.0 | 30 |
| | salt + 1% PAO 7395* | | | | |
| 3 | 0.1% CuChln tetrabutylammonium | 3 | 0 | 2.1 | 0 |
| | hydroxide salt + 1% PAO7395* | | | | |
| 4 | 0.1% CuChln hexamine salt + | 5.9 | 48 | 5.1 | 122 |
| | 1% PAO 7395* | | | | |
| 5 | 0.1% CuChln + 1% PAO 7395* | 6.5 | 63 | 5.4 | 135 |
| 6 | 1% PAO 7395* | 6 | 50 | 4.6 | 100 |
| 7 | 0.1% CuChln + 0.1% surfactant | 3.1 | 0 | 3.4 | 48 |
| | 80** | | | | |
| 8 | 0.1% CuChln + 0.1% surfactant | 4.5 | 13 | 3.9 | 70 |
| | 3273*** | | | | |
| 9 | 0.1% CuChln 0.1% + 0.5% PAO | 4 | 0 | 3.9 | 70 |
| | 4 cst + 0.5% surfactant 3273*** | | | | |
| 10 | 0.1% CuChln + 0.1% surfactant | 4 | 0 | 4.1 | 78 |
| | 3273*** + 0.5% PVP-40 | | | | |
| 11 | 0.1% CuChln acid + 0.1% | 6.9 | 73 | 5.3 | 130 |
| | grinded with 3eq. hexamine + | | | | |
| | 1% PAO 7395* | | | | |

*PAO7395 = 93% PAO 4 cSt + 7% surfactants (mixture of 60% ethoxylated alkyl alcohols and 40% alkyl monoglyceride);
surfactant 80** = Ethoxylated sorbitan trioleate;
surfactant 3273*** = mixture of 60% ethoxylated alkyl alcohols and 40% alkyl monoglyceride

### Example 12: Effect of Treatments on the Emergence, Growth, Yield and Quality of Soybean Seeds

A field experiment was conducted on a sandy soil. Several treatments caused higher stand counts at emergence and advanced plants growth during the growing season compared to the untreated control. All the treatments that caused better stands also resulted in higher yields, seed protein contents and larger seed size than the untreated control. Treatments were applied to the seed as seed treatment before planting, in-furrow at planting and as foliar sprays.

Soybean was planted on May 23, with a John Deere 7000 4-row, no-till corn planter. Plots were planted to be at least 6 m long with 3-m pathways between replications and plots were end-trimmed before harvest to be 6 m long. Fertilizer was applied broadcast on May 30.

Prior to planting seeds that received On-Seed treatments were laid out on plastic sheets on the seed warehouse floor, misted with the appropriate treatment using spray bottles, turned and misted again, before they were allowed to dry and then inserted in the seed hoppers of the planter. The seed was sprayed until the treatment started to run off and then turned and sprayed again. The total rate was approximately 30 ml/kg of seed.

During the in-furrow treatment application, the liquids were delivered right over the planted seed. Each planter unit was calibrated so that it delivered 10 mL of liquid in-furrow treatment per meter of seed row.

Soybean was harvested on September 24, using a Wintersteiger Elite plot combine.

The treatments list is presented in Table 12A below.

TABLE 12A
Treatment list

| | | | Foliar spray | | |
|---|---|---|---|---|---|
| | | | | Plant growth stage | |
| | | | | R1 | R3 |
| | | | | Beginning | Beginning |
| | Seed | In- furrow | V3 | bloom | Pod |
| 1 | water | water | water | water | water |
| 2 | A 0.11% + | A 0.11% + | CuChln 0.1% + | CuChln 0.1% + | CuChln 0.1% + |
| | B* 2% | B* 2% | PAO* 1% | PAO* 1% | PAO* 1% |
| 3 | A 0.11% + | A 0.11% + | CuChln 0.1% + | CuChln 0.1% + | CuChln 0.1% + |
| | B* 2% | B* 2% | PAO* 1% + Ca₂ | PAO* 1% + Ca₂ | PAO* 1% + Ca₂ |
| | | | EDTA | EDTA | EDTA |
| 4 | A 0.11% + | A 0.11% + | CuChln 0.1% + | CuChln 0.1% + | CuChln 0.1% + |
| | B* 2% | B* 2% | PAO* 1% + Cu | PAO* 1% + Cu | PAO* 1% + Cu |
| | | | EDTA | EDTA | EDTA |
| 5 | A 0.22% | A 0.11% + | CuChln 0.2% + | CuChln 0.2% + | CuChln 0.2% + |
| | | B* 2% | PAO* 1% + Ca₂ | PAO* 1% + Ca₂ | PAO* 1% + Ca₂ |
| | | | EDTA 0.05% | EDTA 0.05% | EDTA |
| 6 | M 0.11% + | M 0.11% + | MgChln 0.1% + | MgChln 0.1% + | MgChln 0.1% + |
| | B* 2% | B* 2% | PAO* 1% + Ca₂ | PAO* 1% + Ca₂ | PAO* 1% + Ca₂ |
| | | | EDTA 0.05% | EDTA 0.05% | EDTA 0.05% |
| 7 | M 0.22% | M 0.11% + | MgChln 0.1% + | MgChln 0.1% + | MgChln 0.1% + |
| | | B* 2% | PAO* 1% | PAO* 1% | PAO* 1% |

A: CuChln
B: *PAO = 93% PAO 4 cst + 7% surfactants (mixture of 60% ethoxylated alkyl alcohols and 40% alkyl monoglyceride).
M: MgChln

From the time of emergence there were visible differences among the treatments. Treatment effects on stand counts at emergence (Plants were counted 11 days after planting and again at 14 days after emergence) are shown in Tables 12B and 12C below.

TABLE 12B
Plants Emergence 11 days after planting. Soybean stand Count.

| | | | | Stand |
|---|---|---|---|---|
| | | | % | count |
| Trt | Seed treatment | In-Furrow Treatment | Emergence | plants/m² |
| 1 | water | water | 100 | 27.7 |
| 2 | A 0.11% + B 2% | A 0.11% + B 2% | 151.6 | 41.8 |
| 3 | A 0.11% + B 2% | A 0.11% + B 2% | 158.2 | 43.7 |
| 4 | A 0.11% + B 2% | A 0.11% + B 2% | 156.4 | 43.2 |
| 5 | A 0.22% | A 0.11% + B 2% | 115.9 | 32 |
| 6 | M 0.11% + B 2% | M 0.11% + B 2% | 167.9 | 46.3 |
| 7 | M 0.22% | M 0.11% + B 2% | 154 | 42.5 |

TABLE 12C
Soybean stand count 14 days after plants Emergence.

| | Stand count | | 14 DAE |
|---|---|---|---|
| | Plants/m of row | % of | Vigor score |
| Treatment | number | Control | 1 to 9 (9-best) |
| 1 (Control) | 19.2 | 100.0 | 5.0 |
| 2 | 41.7 | 217.5 | 8.7 |
| 3 | 49.2 | 256.6 | 8.7 |
| 4 | 43.8 | 228.8 | 8.5 |
| 5 | 26.8 | 140.0 | 7.2 |
| 6 | 48.0 | 250.5 | 8.8 |
| 7 | 43.0 | 224.4 | 8.7 |

At V3 Plant growing stage (4 nods have leaves) five consecutive representative plants from 1 row were dig and roots of each plant were evaluated for nodules development. Nodule numbers and dry weight per plant are presented). in Table 12D.

TABLE 12D
Effects of Treatments on Nodules number and dry
weight (mg)/per plant⁻¹ at V3 Plant Stage.

| | |
|---|---|
| Treatment | Nodules/plant⁻¹ NodWt/Pl |

| # | number | weight, g |
|---|---|---|
| 1 (Control) | 3.3 | 8.8 |
| 2 | 4.9 | 9.4 |
| 3 | 7.1 | 12.9 |
| 4 | 6.8 | 10.9 |
| 5 | 3.7 | 7.5 |
| 6 | 7.2 | 9.2 |
| 7 | 6.9 | 11.0 |

At stage V3 (3 trifoliolate leaves), treatments 3, 4, 6 and 7 had significantly more nodules than the control. That indicated that these four treatments, which had good stands and good vigour, were supporting more nodules than all the other treatments. None of the treatments had nodule dry weights that were significantly different than the nodule dry weights of the control. The largest weights were from treatments 3, 4, and 7.

### Plant Heights, Colour Ratings and SPAD Readings at R1 (Beginning Bloom) and R4 (Full Pods)

TABLE 12E
Effects of Treatments on Soybean Plant Heights (cm)
and Visual Colour Ratings Score at R1 and SPAD readings
(plant greenness) at R1 and R4 Plant Stage

| | Plant | Colour Rating | Plant greenness, SPAD | |
|---|---|---|---|---|
| Treatment | Height | Score 1-9 | readings Spad RDG | |
| number | cm | R1 | R1 | R4 |
| 1 (Control) | 41.7 | 5.0 | 34.6 | 45.4 |
| 2 | 50.5 | 6.0 | 36.4 | 45.1 |
| 3 | 50.5 | 5.7 | 37.5 | 44.4 |
| 4 | 49.7 | 6.7 | 37.4 | 44.7 |
| 5 | 44.5 | 6.2 | 35.5 | 46.0 |
| 6 | 50.3 | 6.7 | 36.1 | 44.2 |
| 7 | 48.5 | 6.3 | 36.8 | 45.6 |

At the R1 flower stage of soybean growth , the plants treated with treatments that showed an improvement in emergence and early growth were all significantly taller than the plants from control plots.

At R1, all treatments resulted in higher Color Rating Scores than plants from Control plots.

Also at R1, Treatments 3 and 4 had significantly higher SPAD readings than the control. The SPAD reading results indicated that treatments 2, 3, 4, 6 and 7 had higher chlorophyll contents.

By the R4 stage of development (full pod), none of the SPAD readings were different from the controls.

Soybean Harvest. Seed Yields and Moisture

TABLE 12F
Effects of Treatments on the Yield and seed moisture

| | Soybean Yield | | |
|---|---|---|---|
| Treatment | kg/ha | bu/ac | Moisture, % |
| 1 (Control) | 1835 | 27.3 | 13.1 |
| 2 | 2758 | 41.1 | 13.5 |
| 3 | 2907 | 43.3 | 13.6 |
| 4 | 2723 | 40.5 | 13.3 |
| 5 | 2319 | 34.5 | 13.2 |
| 6 | 3005 | 44.7 | 13.4 |
| 7 | 2793 | 41.6 | 13.4 |

The yields showed significant differences between the control and treatments. Yield was calculated based on 13% moisture adjasment.

Effects of Treatments on Soybean Seed Protein and Oil Content and on 100-seed Weights are presented in Table 12G.

TABLE 12G
Effects of Treatments on the Soybean Seed Protein
and Oil Content* and 100 seeds weight.

| | Soybean seeds quality | | | |
|---|---|---|---|---|
| | | | sample | 100 seed wt |
| Treatment | protein, % | oil, % | moisture, % | g |
| 1 (control) | 40.3 | 20.5 | 10.6 | 16.3 |
| 2 | 41.9 | 20 | 11.1 | 17.5 |
| 3 | 42 | 20.1 | 11.2 | 17.6 |
| 4 | 42 | 20 | 11.1 | 17.4 |
| 5 | 40.8 | 20.4 | 10.7 | 16.6 |
| 6 | 42.1 | 20 | 11 | 17.6 |
| 7 | 41.9 | 20 | 10.8 | 17.4 |

*Soybean Protein and Oil Contents were adjusted to the same moisture, 100 - Seed Weights indicates the Seed Size.

The high-yielding plots all had higher protein contents than the control. Oil contents were slightly lower in all the high-yielding treatments. It is normal in soybeans to have low oil contents if the protein content is higher. The 100-seed weight values indicate that the high-yielding plots consistently had larger seeds than the soybean plants from control.

### SUMMARY

Treatments improved initial plant stands in each plot. The effect was very consistent across all six replications. These treatments also resulted in taller plants than untreated control at R1. They also had higher yields, higher protein contents and larger seed at harvest.

### Example 13: Effect of Treatments on Apple Seedlings Tolerance to Prolonged Drought Stress

In this example, the effects of chlorophyllin compounds and formulations were tested on apple plants (Malus pumila) cv. Northern spy. The experiments were carried out in a greenhouse. Tests were designed to determine the efficacy of compounds on apple seedlings tolerance to drought stress.

In the experiments, apple seedlings were propagated from apple seeds (cv Northern spy), transplanted into 6-inch plastic pots containing professional soil mix (Sunshine LC 1, Sun Gro Horticulture Canada Ltd.) and irrigated with fertilized water on a regular basis.

Apple seedlings at 40-43 cm height were treated with foliar applications of different formulations presented in the table below using hand held Spray bottle (Continental E-Z sprayer) and providing a thorough even coverage. Plants were sprayed two times with 7 days interval.

After first foliar treatment and during the experiment duration, apple seedlings were exposed to reduced water regime (prolonged drought stress) until the wilting point (20 to 30% soil moisture capacity SMC) and re-watered up to 50% SMC. Water limitation regime lasted to the end of the experiment.

Multifactorial experimental design was used for the experiment. Experiment was carried out in a completely randomized design with six replications for each treatment.

TABLE 13
Effect of treatments on apple (cv. Northern spy)
seedlings growth. Two foliar applications.

| | | Shoot growth/plant⁻¹ | | | |
|---|---|---|---|---|---|
| | | Weight | | Height | |
| | | | % | | % |
| # | Treatment | g | increase | cm | increase |
| D | Drought stress - Control | 14.99 | 0 | 32.2 | 0 |
| 1 | 0.1% PAO 7395 + 0.02% CuChIn | 15.03 | 0 | 39.73 | 23 |
| 2 | 0.1% PAO 7395 + 0.12% CuChIn | 14.65 | 0 | 39.63 | 23 |
| 3 | 0.1% PAO 7395 + 0.22% CuchIn | 15.06 | 0 | 38.36 | 19 |
| 4 | 0.3% PAO7395 + 0.02% CuChIn | 14.22 | 0 | 31.35 | 0 |
| 5 | 0.3% PAO7395 + 0.12% CuChIn | 14.22 | 0 | 36.60 | 14 |
| 6 | 0.3% PAO7395 + 0.22% CuChIn | 12.95 | 0 | 38.63 | 20 |
| 7 | 0.5% PAO7395 + 0.02% CuChIn | 15.66 | 4 | 35.20 | 9 |
| 8 | 0.5% PAO7395 + 0.12% CuChIn | 17.19 | 15 | 45.28 | 41 |
| 9 | 0.5% PAO7395 + 0.22% CuChIn | 16.19 | 8 | 36.98 | 15 |

These results show that foliar treatments of CuChIn and PAO 7395 enhanced apple plants shoot growth and improved apple seedlings tolerance to prolonged drought stress.

### Example 14: Effect of Foliar Treatments on Grapevine Seedlings Tolerance to Prolonged Drought Stress

In this example, the effects of chlorophyllin compounds and formulations were tested on grapevine (Vitis vinifera) cv. Riesling. The experiments were carried out in a greenhouse. Tests were designed to determine the activity of compounds on grapevine seedlings tolerance to drought stress.

In the experiments, Pixie grape seedlings were propagated from the rootstocks material and grown in the Greenhouse. Plants were transplanted into 1 gal plastic pots containing professional soil mix (Sunshine LC 1, Sun Gro Horticulture Canada Ltd.) and irrigated with fertilized water on a regular basis. Seedlings were trimmed to 3 shoots to provide the uniformity.

When 5-8 leaves were formed on each shoot, grapevine seedlings were treated with chlorophyllins formulations 3 times with 7 days interval. Grapevine seedlings were treated with foliar applications of different formulations presented in the table below using hand held spray bottle (Continental E-Z sprayer) and providing a thorough even coverage.

After first foliar treatment plants were exposed to prolonged drought stress (water limitations until wilt point (20-25% soil moisture capacity SMC) and at that point re-watered up to 50% SMC. Water limitation regime lasted to the end of the experiment. Grapevine plants were harvested 3 months after the last treatment.

Experiment was carried out in a completely randomized design with six replications for each treatment.

TABLE 14A
Effect of treatments on grapevine growth. Plant biomass Fresh weight).

| | Above ground biomass, fresh weight g/plant⁻¹ | | | | | |
|---|---|---|---|---|---|---|
| | Shoot | | Leaves | | | |
| | | % | | % | | % |
| Treatment | g | increase | number | increase | g | increase |
| Drought stress Control | 15.32 | 0 | 32.8 | 0.00 | 8.19 | 0.00 |
| CuChln 0.12% + PAO7375 0.5% + | 16.44 | 7 | 62.7 | 91 | 20.85 | 155 |
| Ca₂EDTA 0.1% | | | | | | |
| CuChln 0.12% + PAO7395 0.5% + | 16.35 | 7 | 46.8 | 43 | 12.41 | 52 |
| Ca₂EDTA 0.06% | | | | | | |
| CuChln 0.12% + MgChln 0.12% + | 15.20 | 0 | 42.3 | 29 | 13.29 | 62 |
| PAO7395 0.5% | | | | | | |
| CuChln 0.12% + PAO7395 0.5% | 16.63 | 9 | 45.8 | 40 | 13.04 | 59 |
| CuChln 0.12% + PAO7395 0.5% | 18.70 | 22 | 46.5 | 42 | 11.75 | 43 |
| (soil 3X) + (3X foliar) CuChln | | | | | | |
| 0.12% + PAO 0.5% | | | | | | |
| CuChln 0.24% + PAO7395 0.5% | 16.38 | 7 | 51.5 | 57 | 17.86 | 118 |
| CuChln 0.12% + PAO7395 0.75% | 14.57 | 0 | 58.8 | 79 | 16.77 | 105 |
| MgChln 0.12% + PAO7395 0.5% | 17.69 | 15 | 56.5 | 72 | 13.09 | 60 |

TABLE 14B
Effect of treatments on grapevine
growth. Plant biomass (Dry weight).

| | Above ground biomass, | | | |
|---|---|---|---|---|
| | dry weight g/plant⁻¹ | | | |
| | Leaves | | Shoot | |
| | | % | | % |
| Treatment | g | increase | shoot | increase |
| Drought stress Control | 1.87 | 0 | 4.20 | 0 |
| CuChIn 0.12% + PAO7395 0.5% + | 6.32 | 238 | 4.83 | 15.0 |
| Ca₂EDTA 0.1% | | | | |
| CuChIn 0.12% + PAO7395 0.5% + | 4.06 | 117 | 5.44 | 29.6 |
| Ca₂EDTA 0.06% | | | | |
| CuChIn 0.12% + MgChIn 0.12% + | 4.51 | 141 | 5.60 | 33.4 |
| PAO7395 0.5% | | | | |
| CuChIn 0.12% + PAO7395 0.5% | 4.51 | 141 | 5.45 | 30.0 |
| CuChIn 0.12% + PAO7395 0.5% | 4.10 | 119 | 5.77 | 37.5 |
| soil 3X + foliar CuChIn 0.12% + | | | | |
| PAO7395 0.5% | | | | |
| CuChIn 0.24% + PAO7395 0.5% | 5.67 | 204 | 5.42 | 29.2 |
| CuChIn 0.12% + PAO7395 0.75% | 5.28 | 182 | 4.59 | 9.5 |
| MgChIn 0.12% + PAO7395 0.5% | 3.58 | 92 | 5.26 | 25.3 |

TABLE 14C
Effect of treatments on grapevine yield.

| | Yield, g/plant−¹ | | | |
|---|---|---|---|---|
| | Berry | | | |
| | num- | % | weight, | % |
| Treatment | ber | increase | g | increase |
| Drought stress Control | 12.7 | 0.00 | 11.19 | 0.00 |
| CuChIn 0.12% + PAO73950.5% + | 12.3 | 0 | 14.04 | 25 |
| Ca₂EDTA 0.1% | | | | |
| CuChIn 0.12% + PAO7395 0.5% + | 11.3 | 0 | 11.29 | 1 |
| Ca₂EDTA 0.06% | | | | |
| CuChIn 0.12% + MgChIn 0.12% + | 16.7 | 32 | 17.96 | 60 |
| PAO7395 0.5% | | | | |
| CuChIn 0.12% + PAO7395 0.5% | 8.5 | 0 | 10.91 | 0 |
| CuChIn 0.12% + PAO7395 0.5% | 12.7 | 0 | 14.79 | 32 |
| soil 3X + foliar CuChIn 0.12% + | | | | |
| PAO7395 0.5% | | | | |
| CuChIn 0.24% + PAO7395 0.5% | 16.7 | 32 | 17.35 | 55 |
| CuChIn 0.12% + PAO7395 0.75% | 26.7 | 111 | 26.65 | 138 |
| MgChIn 0.12% + PAO7395 0.5% | 6.3 | 0 | 7.48 | 0 |
| Water Control | 8.0 | 0 | 13.92 | 24 |

The results showed that treatments enhanced grapevine plants growth in comparison with drought control plants. Treatment applications resulted in greater shoots, leaves biomass (fresh and dry weight) and grape production and increased plants tolerance to prolonged drought stress.

### Example 15: Effect of Foliar Treatments on Grapevine Tolerance to Salinity Stress

In this example, the effects of chlorophyllin compounds and formulations were tested on grapevine Pixie grape (Vitis vinifera) cv. Cabernet Franc. The experiments were carried out in a greenhouse. Tests were designed to determine the activity of compounds on grapevine seedlings tolerance to salinity stress.

In the experiments, grapevine seedlings were propagated from the rootstock material in the greenhouse. Plants were planted into 1 gal plastic pots containing professional soil mix (Sunshine LC 1, Sun Gro Horticulture Canada Ltd.) and irrigated with fertilized water on a regular basis. All plants were trimmed to 3 shoots. When 5-6 leaves were formed on each shoot, grapevine plants were treated with CuChIn formulations 3 times with 7 days interval. Formulations presented in the table below were applied as a foliar spray using hand held Spray bottle (Continental E-Z sprayer) and providing a thorough even plant coverage.

After first treatment plants were exposed to gradually increased salt stress by watering with 50 mM (2 times) to 100 mM (1 time) of NaCl solution and later maintained with 50 mM NaCl regular salting.

TABLE 15A
Effect of CuChln treatments on grapevine tolerance
to salt stress. Grapevine biomass (Fresh weight).

| | Above ground biomass. Fresh weight, g/plant⁻¹ | | | | | |
|---|---|---|---|---|---|---|
| | | % | | % | | % |
| Treatment | shoot | increase | leaves | increase | total | increase |
| Salt control | 13.43 | 0 | 10.08 | 0 | 23.50 | 0 |
| CuChln 0.15% + PAO 7395* 0.5% + | 17.91 | 33 | 11.95 | 19 | 29.84 | 27 |
| Ca₂EDTA 0.1% | | | | | | |
| CuChln 0.25% + PAO 7395* 0.5% + | 12.70 | 0 | 14.58 | 45 | 27.28 | 16 |
| Ca₂EDTA 0.06% | | | | | | |
| CuChln 0.15% + PAO 7395* 0.5% + | 12.68 | 0 | 8.66 | 0 | 21.34 | 0 |
| Ca₂EDTA 0.06% | | | | | | |
| CuChln 0.15% + PAO 7395* 0.5% + | 16.92 | 26 | 12.39 | 23 | 29.3 | 25 |
| MgChln 0.15% | | | | | | |

*PAO7395: (93 wt % PAO 4 cSt + 7 wt % surfactants (mixture of ethoxylated alkyl alcohols and alkyl monoglyceride))

TABLE 15B
Effect of CuChln treatments on grapevine tolerance
to salt stress. Grapevine biomass (Dry weight).

| | Above ground biomass. Dry weight, g/plant | | | | | |
|---|---|---|---|---|---|---|
| | | % | | % | | % |
| Treatment | shoot | increase | leaves | increase | total | increase |
| Salt control | 2.79 | 0 | 3.49 | 0 | 14.42 | 0 |
| CuChln 0.15% + PAO 7395 0.5% + | 3.45 | 24 | 5.16 | 48 | 16.6 | 15 |
| Ca₂EDTA 0.1% | | | | | | |
| CuChln 0.25% + PAO7395 0.5% + | 3.36 | 20 | 4.05 | 16 | 15.71 | 9 |
| Ca₂EDTA 0.06% | | | | | | |
| CuChln 0.15% + PAO7395 0.5% + | 2.94 | 0 | 3.27 | 0 | 14.86 | 0 |
| Ca₂EDTA 0.06% | | | | | | |
| CuChln 0.15% + PAO7395 0.5% + | 3.96 | 42 | 4.73 | 36 | 17.18 | 19 |
| MgChln 0.15% | | | | | | |

The results showed that foliar CuChIn based treatments enhanced plant vigor and alleviated salinity stress. Best formulation was a mix of CuChIn and MgChIn with PAO 7395. Addition of 0.1% Ca2EDTA to CuChIn enhanced plant vigor and lead to plant biomass increase.

### Example 16: Effect of Soybean Seed Treatments on Soybean Plants Emergence Under Cold Stress Condition

In this example, the effects of chlorophyllin compounds and formulations were tested on soybean. The experiments were carried out in a Growth chamber (Conviron, Canada) in controlled conditions. Tests were designed to determine the activity of compounds on soybean plants emergence under cold stress.

In this experiment, soybean seeds cv. Pioneer P06T28R were treated with treatments listed below and 20 seeds/treatment were sown at 2cm depth into the plastic cells contain moist professional soil mix (Sunshine LC 1, Sun Gro Horticulture Canada Ltd.). Cells were placed in the Growth chamber set under a 16/8 hours light/dark photoperiod, temperature of 15° C. and 65% relative humidity. Plants emergence (cotyledon exposure) was evaluated every day in the morning and evening (day after treatment DAT) and numbers of emerged seedlings were recorded. Seed treatment: 100 g seeds were placed into the plastic bag, 2 ml of treatment solution introduced to the seeds, seeds were shaken for 1 min and later air-dried. The formulations and results are presented in Table 16A and Table 16B below.

TABLE 16A
Effect of soybean seeds treatment on plants
emergence under cold stress condition.

| | Plant emergence (number of plants emerged) | | | | | |
|---|---|---|---|---|---|---|
| | 10 DAT | | 11 DAT | | 12 DAT | |
| | | % | | % | | % |
| Treatment | # | increase | # | increase | # | increase |
| Water Control | 5 | 0 | 10 | 0 | 11 | 0 |
| 0.1% CuChln + 5% PAO* | 10 | 100 | 16 | 60 | 18 | 64 |
| 0.1% CuChln + 2% PAO* | 13 | 160 | 17 | 70 | 17 | 55 |
| 0.1% CuChln | 6 | 20 | 11 | 10 | 15 | 36 |
| 0.1% MgChln + 5% PAO* | 10 | 100 | 14 | 40 | 15 | 36 |

*PAO: (93 wt % PAO 4 cSt + 7 wt % surfactants (mixture of ethoxylated alkyl alcohols and alkyl monoglyceride))

TABLE 16B
Effect of soybean seeds treatment on plants
emergence under cold stress condition.

| | Plant emergence (number of plants emerged) | | | | | |
|---|---|---|---|---|---|---|
| | 10 DAT | | 11 DAT | | 12 DAT | |
| | | % | | % | | % |
| Treatment | # | increase | # | increase | # | increase |
| Water Control | 1 | 0 | 10 | 0 | 13 | 0 |
| 0.75% PAO* + 0.2% CuChln | 4 | 300 | 13 | 30 | 20 | 54 |
| 0.75% PAO* + 0.12% CuChln | 5 | 400 | 18 | 80 | 20 | 54 |
| 0.5% PAO* + 0.2% CuChln | 2 | 100 | 16 | 60 | 20 | 54 |
| 0.5% PAO* + 0.12% CuChln | 3 | 200 | 11 | 10 | 18 | 38 |
| 0.25% PAO* + 0.12% CuChln | 3 | 200 | 18 | 80 | 18 | 38 |
| 0.12% CuChln + 0.04% Atlox 3273 | 1 | 0 | 15 | 50 | 18 | 38 |

These results showed that chlorophyllin formulations stimulate soybean seeds germination and lead to earlier soybean seedlings emergence under cold stress conditions. The addition of oil (PAO) promoted earlier seed germination and plant emergence.

### Example 17: Effect of Treatments on Strawberry Plants (Fragaria x ananassa) Tolerance to Salt Stress

In this example, the effects of chlorin compounds and formulations were tested on strawberry plants (Fragaria x ananassa) cv Temptation (Ball Seeds, USA). The experiments were carried out in a greenhouse. The tests were designed to determine the activity of compounds on strawberry plants tolerance to salt stress.

In the experiments, seedlings of strawberry plants were grown in 5-inch plastic pots filled with professional soil mix (Sunshine LC 1, Sun Gro Horticulture Canada Ltd.) and irrigated with fertilized water on a regular basis. The strawberry plants at 4-5 leaf stage were treated with 4 foliar applications of different Suncor formulations using hand hold Spray bottle (Continental E-Z sprayer) providing an even coverage. The plants were sprayed every 7 days. Twenty four hours after the initial spray, the plants were exposed to salinity stress by watering them with 25 mM sodium chloride solution on a 5 to 7 days interval schedule. The experiment was set out in a completely randomized design with 6 replications for each treatment. The results are summarized in Table 17 below.

TABLE 17
Effect of treatments on strawberry plants (Fragaria × ananassa) tolerance to salt stress.

| | Above ground plant biomass. Fresh weight, g/plant⁻¹ | | | | | |
|---|---|---|---|---|---|---|
| | Leaves + | % | Crown + | % | | % |
| Treatment | petiole | increase | flower stem | increase | Total | increase |
| Salt stress Control | 8.41 | 0 | 3.68 | 0 | 12.09 | 0 |
| 0.15% CuChln + 0.5% PAO 7395* + | 9.43 | 12 | 4.6 | 25 | 14.03 | 16 |
| 0.05% Ca₂EDTA | | | | | | |
| 0.15% CuChln + 0.05% Atlox 3273** | 8.99 | 7 | 3.46 | 0 | 12.45 | 3 |
| 0.15% MgChln + 0.5% PAO 7395* + | 10.66 | 27 | 4.69 | 27 | 15.35 | 27 |
| 0.05% Ca₂EDTA | | | | | | |
| 0.15% MgChln + 0.05% Atlox 3273** | 9.15 | 9 | 4.38 | 19 | 13.53 | 12 |

*PAO7395 = 93% PAO 4 cSt + 7% Atlox 3273 (mixture of 60% ethoxylated alkyl alcohols and 40% alkyl monoglyceride);
Atlox 3273** = mixture of 60% ethoxylated alkyl alcohols and 40% alkyl monoglyceride.

The results show that various metalized chlorophyllins may be used with mineral oil and chelates to increase strawberry plants tolerance to salt stress. Addition of PAO 7395 and chelates to chlorophyllins have enhanced plants tolerance to salt stress.

### Example 18: Effect of Treatments on Strawberry Plants (Fragaria x ananassa) Tolerance to Drought Stress

In this example, the effects of chlorophyllin compounds and formulations were tested on strawberry plants (Fragaria x ananassa) cv Temptation (Ball Seeds, USA).

The experiments were carried out in a greenhouse. Tests were designed to determine the activity of compounds on strawberry plants tolerance to drought stress.

In the experiments, seedlings of strawberry plants were grown in 5-inch plastic pots filled with professional soil mix (Sunshine LC 1, Sun Gro Horticulture Canada Ltd.) and irrigated with fertilized water on a regular basis. Strawberry plants at 4-5 leaf stage were treated with 2 foliar applications of different Suncor formulations using hand hold Spray bottle (Continental E-Z sprayer) providing an even coverage. The plants were sprayed with 7 days interval. After first foliar treatment and during the experiment duration, strawberry plants were exposed to drought stress (reduced water regime) until the wilting point (20 to 30% soil moisture capacity—SMC) and then watered up to 50% SMC. The experiment was set out in a completely randomized design with six replications for each treatment. Three weeks after last foliar spray strawberry plants were harvested and plants biomass was recorded. The results are summarized in Table 18 below.

TABLE 18
Effect of treatments on strawberry plants (Fragaria × ananassa) tolerance to drought stress

| | | Above ground plant biomass. Fresh weight, g/plant⁻¹ | | | | | | | |
|---|---|---|---|---|---|---|---|---|---|
| | | Leaves | | | Crown + petiole | | Flower | Total | |
| | | | | % | | % | stem | | % |
| # | Treatment | number | g | increase | g | increase | g | g | increase |
| 1 | Drought stress Control | 15.7 ± 2.6 | 8.46 | 0 | 4.18 | 0 | 0.20 | 12.84 | 0 |
| 2 | 0.15% CuChln + 0.05% Atlox 3273 | 21.2 ± 4.1 | 10.09 | 8 | 4.73 | 13 | 0.45 | 15.27 | 19 |
| 3 | 0.15% CuChln + 0.5% PAO7395 | 31.8 ± 2.5 | 11.0 | 18 | 5.04 | 21 | 0.22 | 16.26 | 27 |

### Example 19: Effect of Treatments on Tomato Plant Tolerance to Heat Stress

In this example, the effects of chlorin compounds and formulations were tested on Tomato cultivar “Tiny Tim” (Stokes seeds, Ontario, Canada). Several experiments were conducted in the greenhouse and Growth Chamber. The tests were designed to determine the activity of compounds on tomato plants tolerance to heat stress.

In the experiments, Tomato transplants were grown in 6″ plastic pots filled with professional soil mix to 5-6 leaves stage in the greenhouse at 22° C.-25° C. and 8 h dark/16 h light photoperiod respectively. Prior to treatments plants were watered to 100% soil mix capacity (SMC). The Tomato plants were treated with two foliar applications of different formulations providing an even coverage (until run-off) using hand hold Spray bottle (Continental E-Z sprayer).

Plants were treated with compounds two times with 7 days interval. Twenty four hours after the first foliar spray plants were placed into a Growth chamber and exposed to temperature stress (heat stress) for 10 days. Prior to the second treatment tomato plants were maintained at 25° C. for two days and watered to 100% SMC. After second foliar spray plants were placed for a second time into the Growth chamber and exposed to temperature stress (heat stress) for another 10 days. The Tomato plants were regularly watered to avoid water deficit.

The Growth chamber was set at 16 h light/8 h dark photoperiod, illumination at 300 μmol·m⁻² s⁻¹ during the light photoperiod and 70% relative humidity. Temperature regime in the Growth chamber was set at 25° C. during the dark. During the day time (light) plants were exposed to temperature stress with the gradual increase of temperatures from 25° C. to 38° C. during 4 hours, then to heat stress at 38° C. for 8 hours and later gradual decrease of temperatures from 38° C. to 25° C. for 4 hours.

Plants were moved from the Growth Chamber to the greenhouse and maintained in the greenhouse for four days prior to harvest. Twenty-seven days after the first treatment, plants were harvested, and biomass were recorded. Untreated plants—Heat stress Control was used as a reference for each measurement respectively. The experiments were set out in a completely randomized design with 6 replications for each treatment. The results from the experiments are summarized in Tables 19A, 19B and 19C below.

TABLE 19A
Effect of treatments on Tomato tolerance to
heat stress measured by Shoots fresh weight

| | | Above ground plant biomass. | |
|---|---|---|---|
| | | Fresh weight, g/plant⁻¹ | |
| | | Total shoots | |
| # | Treatment | g | % increase |
| 1 | Heat stress Control | 33.51 | 0 |
| 2 | 0.15% CuChIn | 37.17 | 11 |
| 3 | 0.5% PAO 7395* | 36.89 | 10 |
| 4 | 0.15% CuChIn + 0.5% PAO 7395* | 38.33 | 14 |
| 5 | 0.05% Ca₂EDTA | 34.62 | 3 |
| 6 | 0.15% CuChIn + 0.5% PAO 7395* + | 40.76 | 22 |
| | 0.05% Ca₂EDTA | | |

*PAO7395 = 93% PAO 4 cSt + 7% surfactants (mixture of 60% ethoxylated alkyl alcohols and 40% alkyl monoglyceride).

TABLE 19B
Effect of treatments on Tomato tolerance to
heat stress measured by Shoots dry weight

| | | Above ground plant biomass. | |
|---|---|---|---|
| | | Dry weight, g plant⁻¹ | |
| | | Total shoots | |
| # | Treatment | g | % increase |
| 1 | Heat stress Control | 4.46 | 0 |
| 2 | 0.15% CuChIn | 4.92 | 10 |
| 3 | 0.05% Ca₂EDTA | 4.72 | 6 |
| 4 | 0.15% CuChIn + 0.05% Ca₂EDTA | 5.13 | 15 |

TABLE 19C
Effect of treatments on Tomato tolerance to
heat stress measured by Roots dry weight

| | | Roots dry weight, g/plant−¹ | |
|---|---|---|---|
| # | Treatment | g | % increase |
| 1 | Heat stress Control | 0.93 | 0 |
| 2 | 0.15% CuChIn | 1.17 | 26 |
| 3 | 0.5% PAO 7395* | 0.95 | 2 |
| 4 | 0.05% Ca₂EDTA | 1.07 | 15 |
| 5 | 0.15% CuChIn + 0.5% PAO7395 + | 1.28 | 38 |
| | 0.05% Ca₂EDTA | | |

*PAO7395 = 93% PAO 4 cSt + 7% surfactants (mixture of 60% ethoxylated alkyl alcohols and 40% alkyl monoglyceride)

Foliar applications of the copper chlorophyllin formulations with PAO 7395 (0.15% CuChIn+0.5% PAO 7395) and chelates (0.15% CuChIn+0.5% PAO+0.05% Ca₂EDTA) significantly increased plant biomass fresh and dry matter (leaves, shoots, roots) accumulation and tolerance to heat stress.

### Example 20: Effect of Treatments on Tomato Plant Tolerance to Drought Stress

In this example, the effects of chlorin compounds and formulations were tested on Tomato cultivar “Tiny Tim” (Stokes seeds, Ontario, Canada). The experiments were conducted in a Growth Chamber. The tests were designed to determine the activity of compounds on tomato plants tolerance to drought stress in controllable conditions.

In the experiments, tomato transplants were grown in 6″ plastic pots filled with professional soil mix (Sunshine LC 1, Sun Gro Horticulture Canada Ltd.) to 4-5 leaves stage in the greenhouse at 22° C.-25° C. and 8 h dark/16 h light photoperiod respectively. Prior to treatments plants were watered to 100% SMC. Plants were treated with compounds two times with 7 days interval. Hand hold Spay bottle (Continental E-Z sprayer) was used for spays providing an even coverage (foliar spray to run-off). Twenty hours after the first foliar spray, the plants were placed into a Growth chamber for ten days and exposed to drought stress. Growth chamber was set at 25° C., 16 h light/8 h dark photoperiod, illumination at 300 μmol·m⁻² s⁻¹ during the light photoperiod and 70% relative humidity. The Tomato plants were watered up to 50% SMC at wilting point (20-30% SMC). Prior to the second treatment tomato plants were watered to 100% field capacity. After second foliar spray plants were placed into the Growth chamber and exposed to drought stress for another 10 days.

Then plants were moved from the Growth Chamber to the greenhouse and maintained in the greenhouse for 4 days prior to harvest. Twenty five days after the first treatment, plants were harvested, fresh and dry plant weights (biomass) were recorded. Untreated plants—Drought stress Control was used as a reference for each measurement respectively. The experiment was set out in a completely randomized design with 6 replications for each treatment. The results are summarized in Table 20 below.

TABLE 20
Effect of treatments on tomato plants tolerance to drought stress.

| | | Above ground biomass. Fresh weight, g/plant⁻¹ | | | | | |
|---|---|---|---|---|---|---|---|
| | | | | Stem + trusses + | | | |
| | | Leaves | | green fruit | | Total shoots | |
| | | | % | | % | | % |
| # | Treatment | g | increase | g | increase | g | increase |
| 1 | Drought stress Control | 31.16 | 0 | 13.73 | 0 | 44.90 | 0 |
| 2 | 0.15% CuChln | 34.52 | 11 | 14.28 | 4 | 48.80 | 9 |
| 3 | 0.15% CuChln + 0.05% Ca₂EDTA | 34.90 | 12 | 14.52 | 6 | 49.42 | 10 |
| 4 | 0.15% CuChln + 0.5% PAO 7395* + | 36.43 | 17 | 15.16 | 10 | 51.58 | 15 |
| | 0.05% Ca₂EDTA | | | | | | |

*PAO7395 = 93% PAO 4 cSt + 7% surfactants (mixture of 60% ethoxylated alkyl alcohols and 40% alkyl monoglyceride).

The results showed that chlorophyllin may be used with mineral oil and chelate. Addition of PAO 7395 and chelate to chlorophyllin enhanced plants tolerance to drought stress and increased plants biomass production.

### Example 21: Effect of Treatments on Tomato Plant Tolerance to Drought Stress

In this example, the effects of chlorin compounds and formulations were tested on tomato plants cv. “Tiny Tim” (Stokes seeds, Ontario, Canada). The experiments were carried out in a greenhouse. Tests were designed to determine the activity of compounds on tomato plants tolerance to drought stress.

In the experiments, tomato plants cv. Tiny Tim were transplanted to 6″ plastic pots containing industrial soil mix (Sunshine LC 1, Sun Gro Horticulture Canada Ltd.) and maintained in the greenhouse. At 5 to 6 leaves stage, plants were watered to 100% soil mix capacity (SMC) and treated (foliar spray to run-off) with tested solutions using hand hold Spray bottle (Continental E-Z sprayer). Then plants were subjected to prolong drought stress during the growing period. At wilting point (20-30% SMC) plants were watered up to 50% SMC. Foliar treatments were applied 2 times with 7 days interval. Plants were grown in the greenhouse and arranged in a completely randomized design with 6 replications per treatment. Three weeks after second foliar treatment tomato plants were harvested and plants biomass (fruits, shoots) was assessed. The results are summarized in Table 21 below.

TABLE 21
Effect of treatments on tomato plants tolerance to prolonged drought stress.

| | | | Above ground plant biomass g/plant⁻¹ | | | | | |
|---|---|---|---|---|---|---|---|---|
| | Green fruit, plant⁻¹ | | Shoots | | | | Shoots and fruit | |
| | | % | Fresh | % | Dry | % | | % |
| Treatment | g | increase | weight | increase | weight | increase | g | increase |
| Drought stress control | 4.48 | 0 | 49.04 | 0 | 8.91 | 0 | 53.62 | 0 |
| 0.15% CuChln + 0.05% Atlox 3273 | 3.21 | 0 | 55.48 | 13 | 9.24 | 4 | 58.69 | 9 |
| 0.15% CuChln + 0.5% PAO7395* | 9.55 | 113 | 61.96 | 26 | 9.87 | 11 | 71.51 | 33 |

*PAO7395 = 93% PAO 4 cSt + 7% Atlox 3273; Atlox 3273 = mixture of 60% ethoxylated alkyl alcohols and 40% alkyl monoglyceride.

### Example 22: Effect of Treatments on the Emergence, Growth, Yield and Quality of Soybean Seeds

A field experiment was conducted on a sandy soil. Several treatments resulted in advanced plants growth during the growing season, greater 1000 seeds weight and in higher yields compared to the untreated control. Treatments were applied to the seed as seed treatment before planting, in-furrow at planting and as foliar sprays at V3, R1 and R3 soybean plant stage.

Soybean cv Asgrow AG33X8 was planted using a John Deere 7000 4-row, no-till planter. Plots were arranged in a completely randomized block design with four replications. Each plot was 6 m long with 4 rows of soybean and 3-m pathways between the blocks. Fertilizer was broadcast prior to planting.

Prior to planting, the seeds received On-Seed treatments. Seeds were placed into the large bags and treatment slurry was introduced into the bag in the amount required for even seed coverage. Bags were shaken for few minutes and then seeds were air dried on the plastic sheets on the warehouse floor.

During the in-furrow treatment, the liquids were delivered right over the planted seed. Each planter unit was calibrated so that it delivered 10 mL of liquid in-furrow treatment per meter of seed row. Soybean was harvested using a Kinkaid *XP plot combine. Soybean yield data was adjusted to 13% moisture content. The treatment list is presented in Table 22A below.

TABLE 22A
Treatment list

| | | Foliar spray | | |
|---|---|---|---|---|
| | | Plant growth stage | | |
| | | | R1 | R3 |
| | | | Beginning | Beginning |
| Seed | In-furrow | V3 | Flowering | Pod |

| | | | |
|---|---|---|---|
| 1 | water | water | water |
| 2 | CuChIn 1% + | CuChIn 0.15% + | CuChIn 0.15% + |
| | PAO* 1% | PAO* 1% | PAO* 1% |
| 3 | CuChIn 1% + | CuChIn 0.15% + | CuChIn 0.15% + PAO* 1% + |
| | PAO* 1% | PAO* 1% | Ca₂EDTA 0.05% |
| 4 | CuChIn 1% + | CuChIn 0.15% + | water |
| | PAO* 1% | PAO* 1% | |
| 5 | CuChIn 1% | CuChIn 0.15% | CuChIn 0.15% + 0.07% Atlox |
| | | | 3273** + Ca₂EDTA 0.05% |
| 6 | MgChIn 1% | MgChIn 0.15% + | MgChIn 0.15% + PAO* 1% + |
| | | PAO* 1% | Ca₂EDTA 0.05% |

*PAO = 93% PAO 4 cst + 7% Atlox3273 (mixture of 60% ethoxylated alkyl alcohols and 40% alkyl monoglyceride).
Atlox 3273**: surfactants (mixture of 60% ethoxylated alkyl alcohols and 40% alkyl monoglyceride).

From the time of emergence there were visible differences among the treatments. Seed and in -furrow treatments effect on plants vigor was evaluated using rating scale from 1-9 (at 3 weeks after planting, with 1=severely damaged plants, 3=acceptable plants, 9=health plants). The results are summarized in Tables 22B. Yield data was collected and shown in Table 22C below.

TABLE 22B
Effects of Treatments on plants vigor

| | |
|---|---|
| | Plant Vigor at V3 |
| Treatment | Rating scale 1-9 |

| # | Score | % increase |
|---|---|---|
| 1 | 2.8 | 0 |
| 2 | 3.5 | 25 |
| 3 | 5.3 | 89 |
| 4 | 3.5 | 25 |
| 5 | 5.8 | 107 |
| 6 | 6.5 | 132 |

TABLE 22C
Effects of Treatments on the Yield

| | |
|---|---|
| Treatment | Yield |

| # | bu/acre | % increase |
|---|---|---|
| 1 | 40.9 | 0 |
| 2 | 41.1 | 0.5 |
| 3 | 43.9 | 7.3 |
| 4 | 42.3 | 3.4 |
| 5 | 44.8 | 9.5 |
| 6 | 41.5 | 1.5 |

The yields showed differences between the control and treatments. All treatments resulted in yield increase.

### Example 23: Effect of Soil Drench and Foliar Applications of Treatments on Tomato Plants' Tolerance to Prolonged Drought Stress

This study evaluated effects of foliar application of a chlorin compound with and without oil on physiological fitness of tomatoes under prolonged drought.

Tomato ‘Tiny Tim’ was planted in cells filled with potting mix and transplanted to 1 gallon pots filled with regular greenhouse soil mix (top soil:fine sand, 2:1 v/v) with equal amounts of soil/pot. The soil moisture was determined by drying at 105 C for 48 h. Soil moisture was at 14.6% (at 50% capacity) and 29.2% at 100% capacity. After transplanting, the plants were subjected to drought stress by deficit irrigation (50% capacity). The treatments were applied as foliar spray. First foliar application took place 7 days after transplanting, and 2^{nd} foliar application occurred 14 days after transplanting (7 days after 1^{st} application). Treatment was applied to the foliage uniformly till just runoff by a hand-sprayer (˜5 mL per pot).

The shoot and root biomass of the tomato plant were measured 2 months after the first application of the treatments. The results are shown in Table 23A.

TABLE 23A
Tomato shoot and root biomass affected by the
treatments in the prolonged drought conditions

| | Biomass (g) | | | |
|---|---|---|---|---|
| | | % | | % |
| Treatment | Shoot | increase | Root | increase |
| Untreated Control | 6.45 | 0 | 0.807 | |
| 0.1% CuChIn + 0.035% surfactant3273 | 7.16 | 11 | 0.851 | 5 |
| 0.1% CuChIn + 0.5% PAO7395* | 7.39 | 15 | 0.926 | 15 |

*PAO7395 = 93% PAO 4 cst + 7% surfactants 3272 (mixture of 60% ethoxylated alkyl alcohols and 40% alkyl monoglyceride).

Both treatment increased biomass compared with untreated control under the prolonged drought. Moreover, the combination of CuChIn with PAO and surfactant further improved the biomass than CuChIn alone with surfactant.

Leaf proline content was also measured during the testing. Briefly, leaf (50) were homogenized with 1.8 mL 3% sulfosalicylic acid and boiled at 100° C. for 10 min, 1 mL of the supernatant was mixed with 1 mL acetic acid and 1 mL acidic ninhydrin and heated at 100° C. for 40 min, the reaction mixture was extracted with 2 mL toluene after cooling and absorbance was read at 520 nm. Proline accumulation in stressed plants has a protective function. It has been known that plants resistant to drought and salt stress show high proline content. High proline content provides osmoprotection to cells and stabilizes cellular homeostasis under stress, as a result of which cellular membranes and machinery are less damaged during stress. In addition higher cellular proline content has been shown to aid in recovery from stress.

The results of proline content are shown in Table 23B. This example showed that application of a chlorin compound with an oil activated a higher proline accumulation, inducing osmotic adjustment under drought stress.

TABLE 23B
Proline content of tomato plants under prolonged drought stress

| | Proline (μg/g FW) | | |
|---|---|---|---|
| | Time after treatment (day) | | |
| Treatment | 0 | 7 | 14 |
| Watered Control | 86.7 | 85.2 | 91 |
| Drought Control | 87.1 | 101.6 | 99.4 |
| 0.1% CuChIn + 0.035% surfactant3273 | 89.8 | 110.1 | 335 |
| 0.1% CuChIn + 0.5% PAO7395* | 85.7 | 116.8 | 371.9 |

*PAO7395 = 93% PAO 4 cst + 7% surfactants 3272 (mixture of 60% ethoxylated alkyl alcohols and 40% alkyl monoglyceride).

### Example 24: Effect of Different Oil on Arabidopsis Salt Stress

The experimental protocol is the same as that of Example 2.

In this example, the effect of metalized chlorin compounds and various oils on Arabidopsis thaliana senescence triggered by salt stress was measured by a visual rating scale reflecting progressive leaf senescence symptoms. In particular, it was shown that CuChIn provided protection against senescence triggered by salt stress. It was also shown that the addition of oil further increased the protection.

After prolonged exposure to salt stress, Na⁺ accumulation in the shoot results in cytotoxic effects, whereby the most visible symptom is yellowing, followed by drying of leaves, due to leaf senescence and death. Leaf senescence may be evaluated by visual scoring reflecting progressive leaf senescence symptoms.

To determine the effect of CuChI on plant senescence triggered by salt stress, seeds were sown directly on soil, the pots were watered and placed under a 16/8 h photoperiod, PAR 24 micro mol/m2/s, 25° C.+/−3 temperature and 65% relative humidity. After 14 days seedlings were irrigated with half-strength formulation and 24 h later watered to capacity with 100 mM NaCl followed by 200 mM NaCl four days later and finally 300 mM NaCl every 4 four days till the end of the experiment. %improvement is an average of two independent experiments. The results are summarized in Tables 24A and 24B below.

TABLE 24A
Effect of combining CuChIn with unsaturated oils.

| Treatment | % improvement* |
|---|---|
| 0.05% CuChIn + 0.0175% surfactant 3273 | 26.5 |
| 0.12% Squalene** | 37.5 |
| 0.05% CuChIn + 0.12% Squalene** | 108 |

*values are % sensecence improvement relative to untreated control
**Squalane = 93 wt % Squalene + 7 wt % surfactant 3273 (mixture of ethoxylated alkyl alcohols and alkyl monoglyceride)

TABLE 24B
Effect of combining CuChIn with Metallocene
Polyalphaolefin (mPAO)

| Treatment | % increase* |
|---|---|
| 0.05% CuChIn + 0.0175% surfactant3273 | 36.5 |
| 0.25% SpectraSyn Elite 150** | 27.5 |
| 0.05% CuChIn + 0.12% SpectraSyn Elite 150** | 54.6 |

*values are % sensecence improvement relative to untreated control
**SpectraSyn Elite 150 (93 wt % SpectraSynElite 150 + 7 wt % surfactant 3273 (mixture of ethoxylated alkyl alcohols and alkyl monoglyceride))

1.-256. (canceled)

257. A composition for increasing resistance of a plant to one or more abiotic stress, the composition comprising:
a macrocyclic tetrapyrrole compound selected from the group consisting of a porphyrin, a reduced porphyrin, and a mixture thereof; and
an oil selected from the group consisting of a mineral oil, a vegetable oil and a mixture thereof.

258. The composition of claim 257, wherein the one or more abiotic stress is selected from the group consisting of cold stress, heat stress, water stress, transplant shock stress, low light stress, photooxidative stress, drought stress and salinity stress.

259. The composition of claim 257, wherein the reduced porphyrin compound is a chlorin.

260. The composition of claim 257, wherein the macrocyclic tetrapyrrole compound is complexed with a metal to form a metallated macrocyclic tetrapyrrole compound.

261. The composition of claim 260, wherein the metal is selected such that, in response to light exposure, the metallated photosensitive compound generates reactive oxygen species (ROS).

262. The composition of claim 261, wherein the metal is selected from the group consisting of Mg, Zn, Pd, Sn, Al, Pt, Si, Ni, Ge, Ga and In.

263. The composition of claim 260, wherein the metal is selected such that the metallated macrocyclic tetrapyrrole compound does not generate singlet oxygen.

264. The composition of claim 263, wherein the metal is selected from the group consisting of Cu, Co, Fe and Mn.

265. The composition of claim 257, wherein the macrocyclic tetrapyrrole compound is not complexed with a metal.

266. The composition of claim 257, wherein the macrocyclic tetrapyrrole compound comprises chlorophyllin, PP9, TPP or a mixture thereof.

267. The composition of claim 257, wherein the macrocyclic tetrapyrrole compound is provided at a concentration between about 5 μM and about 100 mM.

268. The composition of claim 257, wherein the macrocyclic tetrapyrrole compound and the oil are present in amounts that are synergistically effective for increasing resistance of the plant to at least one of the one or more abiotic stress.

269. The composition of claim 257, wherein the macrocyclic tetrapyrrole compound and the oil are applied in a relative proportion between about 50:1 and about 1:5000 by weight.

270. The composition of claim 257, further comprising a chelating agent.

271. The composition of claim 270, wherein the chelating agent comprises an amino polycarboxylic acid compound or a salt thereof.

272. The composition of claim 271, wherein the macrocyclic tetrapyrrole compound and the amino polycarboxylic acid compound or salt thereof are present in amounts that are synergistically effective for increasing resistance of the plant to at least one of the one or more abiotic stress.

273. The composition of claim 270, wherein the macrocyclic tetrapyrrole compound and the chelating agent are applied in a relative proportion between about 50:1 and about 1:1000 by weight.

274. The composition of claim 257, further comprising a surfactant.

275. The composition of claim 257, wherein the plant is a non-woody crop plant, a woody plant or a turfgrass.

276. The composition of claim 257, wherein the plant is a seed or a seedling.

277. The composition of claim 276, which is a coating-composition, further comprising:
an aqueous carrier medium; and
a resin dispersible in the aqueous carrier medium for coating the seed or seedling, the resin comprising a polymeric species.

278. The composition of claim 277, wherein the polymeric species is selected from the group consisting of acrylics, polyurethanes, urethane acrylics, polyesters and uralkyds.

279. The composition of claim 277, wherein the polymeric species is film-forming.
